(19) United States
(12) Patent Application Publication
(10) Pub. No.: US 2011/0190970 A1
(43) Pub. Date: Aug. 4, 2011

(54) POWER GENERATION DEVICE EQUIPPED ON VEHICLE

(75) Inventors: Kazunari MORIYA, Seto-shi (JP); Hideo NAKAI, Nisshin-shi (JP); Yuichi OHTERU, Aichi-ken (JP); Eiji YAMADA, Owariasahi-shi (JP); Makoto HIRAI, Susono-shi (JP); Toru ANDO, Toyota-shi (JP); Ryoji MIZUTANI, Nagoya-shi (JP); Kenji KIMURA, Miyoshi-shi (JP); Mitsumasa FUKUMURA, Susono-shi (JP); Hidehiro OBA, Aichi-gun (JP)

(73) Assignees: KABUSHIKI KAISHA TOYOTA CHUO KENKYUSHO, AICHI-GUN (JP); TOYOTA JIDOSHA KABUSHIKI KAISHA, TOYOTA-SHI (JP)

(21) Appl. No.: 13/004,432

(22) Filed: Jan. 11, 2011

(30) Foreign Application Priority Data
Jan. 13, 2010 (JP) 2010-004629
Jan. 11, 2011 (JP) 2011-002700

(51) Int. Cl. B60W 20/00; B60W 10/06; B60W 10/08

(52) U.S. Cl. 701/22; 180/65.265; 903/930

(57) ABSTRACT

A structure for controlling an engine is simplified in a power generation device equipped on a vehicle which generates power by a driving force of an engine. An operation unit (32) outputs to a controller (12) drive operation information based on an operation of a user. The controller (12) controls a vehicle driving circuit (28) and determines an engine output power target value based on the drive operation information and a running state of the vehicle. An engine output power/control voltage table stored in a storage unit (34) is referred to, and a value of a control voltage (Va) correlated to the engine output power target value is determined. The controller (12) controls a voltage adjusting circuit (24) such that the control voltage (Va) is set to the value determined based on the engine output power/control voltage table.

### PRIORITY INFORMATION

This application is based on and claims priority from Japanese Patent Application No. 2010-004629 filed on Jan. 13, 2010 and Japanese Patent Application No. 2011-002700 filed on Jan. 11, 2011, the entire disclosure of which, including the specification, claims, drawings, and abstract, is incorporated herein by reference in its entirety.

### BACKGROUND

1. Technical Field

The present invention relates to a power generation device equipped on a vehicle which generates power by the driving force of an engine.

2. Background Art

Series hybrid automobiles are widely researched and developed. In a series hybrid automobile, a generator is driven by the torque of an engine to generate power, and a running motor is driven by the generated power, to run the vehicle. Among the power generated by the generator, the power that is not used for running of the vehicle and a regenerative power derived from the running motor are supplied to a secondary battery which can be repeatedly charged and discharged. The power charged to the secondary battery is supplied to the running motor according to a running control and is used as running power. With the series hybrid automobile, the regenerative power can be used for the running power, and the power generated by the engine can compensate for insufficiency of the running power.

JP H6-245322 A discloses a series hybrid automobile in which a rectifier for rectifying an alternate current (AC) generated voltage which is output by the generator is provided. A direct current (DC) voltage which is output by the rectifier is applied to the secondary battery (battery) after the voltage value is adjusted by a voltage boosting chopper circuit. JP H6-245322 A discloses that the voltage of the battery is controlled by controlling the voltage boosting chopper circuit.

### SUMMARY

### Technical Problem

In a series hybrid automobile, the engine is controlled according to a rotational state of the running motor, the charge state of the secondary battery, etc. The control of the engine is executed by controlling a throttle for adjusting a flow rate of fuel supplied to the engine. However, because the control of the throttle is a mechanical control, there has been a problem in that the control mechanism becomes complicated.

In addition, a method for suitably controlling the engine and the generator of the series hybrid automobile according to the running state has not been sufficiently established in the related art.

The present invention was conceived in view of these problems, and an advantage of the present invention is simplification of a structure for controlling the engine in a power generation device equipped on a vehicle which generates power by a driving force of the engine.

Another advantage of the present inventions is that the engine and the generator in the power generation device equipped on a vehicle can be suitably controlled according to the running state.

### Solution to Problem

According to one aspect of the present invention, there is provided a power generation device equipped on a vehicle, comprising an engine which generates torque by combustion of fuel; a generator wherein the engine and the generator apply torque to each other; a power adjusting unit to which the generator is connected, and which sends and receives power to and from a vehicle driving unit that drives the vehicle with the power and which adjusts the power sent to and received from the vehicle driving unit; and a target drive state determining unit which determines a target drive state of the engine according to a control state of the vehicle, wherein the power adjusting unit comprises a conversion circuit which converts alternate current power generated by the generator into direct current power and outputs the direct current power to a power path to the vehicle driving unit, and a voltage adjusting circuit which adjusts a direct current transmission voltage which is transmitted to the power path between the conversion circuit and the vehicle driving unit, and the power adjusting circuit adjusts the direct current transmission voltage according to the target drive state.

According to another aspect of the present invention, it is preferable that, in the power generation device equipped on a vehicle, the voltage adjusting circuit comprises an electricity accumulating unit which can be repeatedly charged and discharged, and a voltage boosting/reducing converter circuit which converts a voltage between the direct current transmission voltage and an output voltage of the electricity accumulating unit.

According to another aspect of the present invention, it is preferable that the power generation device equipped on a vehicle further comprises a reverse direction conversion circuit which converts direct current power into alternate current power, wherein the reverse direction conversion circuit converts direct current power based on the direct current transmission voltage into alternate current power, and outputs the alternate current power to a power path to the generator, so that the generator causes the engine to start.

According to another aspect of the present invention, there is provided a power generation device equipped on a vehicle, comprising an engine which generates torque by combustion of fuel; a generator wherein the engine and the generator apply torque to each other; and a power adjusting unit to which the generator is connected, and which sends and receives power to and from a vehicle driving unit that drives the vehicle with the power and which adjusts the power sent to and received from the vehicle driving unit, wherein the power adjusting unit comprises a conversion circuit which converts alternate current power generated by the generator into direct current power and outputs the direct current power to a power path to the vehicle driving unit, and a voltage adjusting circuit which adjusts a direct current transmission voltage which is transmitted to the power path between the conversion circuit and the vehicle driving unit, the generator operates in a generator operation range in a rotation rate-torque characteristic in which torque applied to the generator increases with an increase in a rotation rate of the generator under a condition that the direct current transmission voltage is constant, and a rotation rate-torque characteristic for the engine is set such that an engine operation range in the rotation rate-torque characteristic overlaps the generator operation range.

According to another aspect of the present invention, it is preferable that the power generation device equipped on a vehicle further comprises a controller which determines operation conditions of the engine and the generator based on torque applied to the generator and a rotation rate of the generator corresponding to a generation power target value, the rotation rate-torque characteristics for the engine and the generator in an overlapping range of the generator operation range and the engine operation range, and an optimum fuel consumption rate characteristic for the engine in the overlapping range, and controls the engine and the generator based on the operation conditions.

According to another aspect of the present invention, there is provided a power generation device equipped on a vehicle, comprising an engine which generates torque by combustion of fuel; a generator wherein the engine and the generator apply torque to each other; a power adjusting unit to which the generator is connected, and which sends and receives power to and from a vehicle driving unit that drives the vehicle with the power and which adjusts the power sent to and received from the vehicle driving unit; and a controller which controls the power adjusting unit, wherein the power adjusting unit comprises a conversion circuit which converts alternate current power generated by the generator into direct current power and outputs the direct current power to a power path to the vehicle driving unit, and a voltage adjusting circuit which adjusts a direct current transmission voltage which is transmitted to the power path between the conversion circuit and the vehicle driving unit, and the controller comprises a correlating unit which correlates a rotation rate detection value of the generator, a target value of torque applied to the generator, and a target value of the direct current transmission voltage based on a rotation rate-torque characteristic for the generator with the direct current transmission voltage as a parameter, and a voltage adjusting circuit controlling unit which determines a target value of the direct current transmission voltage based on a correlation relationship provided by the correlating unit and which controls the voltage adjusting circuit based on the target value of the direct current transmission voltage.

According to another aspect of the present invention, it is preferable that the power generation device equipped on a vehicle further comprises a rotation rate target value determining unit which determines a rotation rate target value for controlling stopping of the engine, and a torque target value determining unit which determines a target value of torque applied to the generator based on a proportional integration calculation based on a difference between the rotation rate detection value and the rotation rate target value, wherein the voltage adjusting circuit controlling unit determines the target value of the direct current transmission voltage based on the rotation rate detection value and the target value determined by the torque target value determining unit.

According to another aspect of the present invention, there is provided a power generation device equipped on a vehicle, comprising an engine which generates torque by combustion of fuel; a generator wherein the engine and the generator apply torque to each other; and a power adjusting unit to which the generator is connected, and which sends and receives power to and from a vehicle driving unit that drives the vehicle with the power and which adjusts the power sent to and received from the vehicle driving unit, wherein the power adjusting unit comprises a conversion circuit which converts alternate current power generated by the generator into direct current power and outputs the direct current power to a power path to the vehicle driving unit, and a voltage adjusting circuit which adjusts a direct current transmission voltage which is transmitted to the power path between the conversion circuit and the vehicle driving unit, and the voltage adjusting circuit adjusts the direct current transmission voltage based on power to be sent and received between the power adjusting unit and the vehicle driving unit when the generator does not generate power and adjusts the direct current transmission voltage based on power to be generated by the generator when the generator generates power.

According to another aspect of the present invention, there is provided a power generation device equipped on a vehicle, comprising an engine which generates torque by combustion of fuel; a generator wherein the engine and the generator apply torque to each other; and a power adjusting unit to which the generator is connected, and which sends and receives power to and from a vehicle driving unit that drives the vehicle with the power and which adjusts the power sent to and received from the vehicle driving unit, wherein the power adjusting unit comprises a conversion circuit which converts alternate current power generated by the generator into direct current power and outputs the direct current power to a power path to the vehicle driving unit, and a voltage adjusting circuit which adjusts a direct current transmission voltage which is transmitted to the power path between the conversion circuit and the vehicle driving unit, the voltage adjusting circuit comprises an electricity accumulating unit which applies a voltage to the power path to the vehicle driving unit and a converter circuit which boosts a voltage which is output from the generator through the conversion circuit and applies the boosted voltage to the power path to the vehicle driving unit and the electricity accumulating unit as the direct current transmission voltage, and the direct current transmission voltage is adjusted with the voltage boosting operation.

According to another aspect of the present invention, there is provided a power generation device equipped on a vehicle, comprising an engine which generates torque by combustion of fuel; a generator wherein the engine and the generator apply torque to each other; and a power adjusting unit to which the generator is connected, and which sends and receives power to and from a vehicle driving unit that drives the vehicle with the power and which adjusts the power sent to and received from the vehicle driving unit, wherein the power adjusting unit comprises a conversion circuit which converts alternate current power generated by the generator into direct current power and outputs the direct current power to a power path to the vehicle driving unit, and a voltage adjusting circuit which adjusts a direct current transmission voltage which is transmitted to the power path between the conversion circuit and the vehicle driving unit, the voltage adjusting circuit comprises an electricity accumulating unit which applies a voltage to the power path to the vehicle driving unit, and a converter circuit which reduces a voltage which is output from the generator through the conversion circuit and applies the reduced voltage to the power path to the vehicle driving unit and the electricity accumulating unit, and a voltage which is output from the generator through the conversion circuit is set as the direct current transmission voltage, and the direct current transmission voltage is adjusted with the voltage reducing operation.

According to another aspect of the present invention, it is preferable that the power generation device equipped on a vehicle further comprises a vibration inhibition target value determining unit which determines a target value of the direct current transmission voltage for inhibiting a rotational vibration of the generator as a vibration inhibition target value, a running control target value determining unit which determines a target value of the direct current transmission voltage corresponding to a running state and a drive operation of the vehicle as a running control target value, and a vibration inhibition/running control target value determining unit which determines a target value of the direct current transmission voltage as a vibration inhibition/running control target value based on the vibration inhibition target value and the running control target value, wherein the converter circuit operates in a manner such that the direct current transmission voltage reaches the vibration inhibition/running control target value.

According to another aspect of the present invention, it is preferable that, in the power generation device equipped on a vehicle, the vibration inhibition target value determining unit comprises a correlating unit which correlates a rotation rate detection value of the generator, a target value of torque applied to the generator, and a target value of the direct current transmission voltage based on a rotation rate-torque characteristic for the generator with the direct current transmission voltage as a parameter, and a torque target value determining unit which determines a target value of torque applied to the generator for inhibiting the rotational vibration of the generator, and the vibration inhibition target value is determined based on the rotation rate detection value of the generator, the target value determined by the torque target value determining unit, and a correlation relationship by the correlating unit.

According to another aspect of the present invention, it is preferable that, in the power generation device equipped on a vehicle, the generator operates in a generator operation range in a rotation rate-torque characteristic in which torque applied to the generator increases with an increase in a rotation rate of the generator under a condition that the direct current transmission voltage is constant, a rotation rate-torque characteristic for the engine is set such that an engine operation range in the rotation rate-torque characteristic overlaps the generator operation range, the running control target value determining unit comprises a generation power target value determining unit which determines a generation power target value corresponding to the running state and the drive operation of the vehicle, and the running control target value is determined based on torque applied to the generator and a rotation rate of the generator corresponding to the generation power target value, rotation rate-torque characteristics for the engine and the generator in an overlapping range of the generator operation range and the engine operation range, and an optimum fuel consumption rate characteristic for the engine in the overlapping range.

In various aspects of the present invention, the direct current transmission voltage has a meaning as a control voltage for controlling a rotational state of the generator.

### Advantageous Effects of the Invention

According to various aspects of the present invention, in a power generation device equipped on a vehicle which generates power by a driving force of an engine, the structure for controlling the engine can be simplified. In addition, the engine and the generator can be suitably controlled according to the running state.

### BRIEF DESCRIPTION OF THE DRAWINGS

FIG. 1 is a diagram showing a structure of a series hybrid vehicle driving system according to a first preferred embodiment of the present invention.

FIG. 2 is a diagram showing a structure of a rectifier circuit and a voltage boosting/reducing converter circuit.

FIG. 3 is a diagram showing, with a graph, the content of an engine output power/control voltage table.

FIG. 4 is a diagram showing a structure of a series hybrid vehicle driving system according to a second preferred embodiment of the present invention.

FIG. 5 is a diagram showing a structure of an inverter circuit and a voltage boosting/reducing converter circuit.

FIG. 6 is a diagram showing an example structure of a vehicle driving circuit.

FIG. 7 is a diagram showing a structure of a power generation control table.

FIG. 8 is a diagram showing an example rotation rate-torque characteristic for a motor generator.

FIG. 9 is a diagram showing rotation rate-torque characteristics for the engine and the motor generator in an overlapping manner.

FIG. 10 is a diagram showing a structure of a control voltage calculating unit.

FIG. 11 is a diagram showing a structure of a voltage determination table.

FIG. 12 is a diagram showing an example rotation rate-torque characteristic for generating a voltage determination table.

FIG. 13 is a diagram showing a structure of a control voltage calculating unit for executing an engine stop rotation control.

FIG. 14 is a diagram showing a temporal change of the rotation rate when the engine stop rotation control is executed.

FIG. 15 is a diagram showing a structure of a series hybrid vehicle driving system according to a third preferred embodiment of the present invention.

FIG. 16 is a diagram showing a structure of a series hybrid vehicle driving system according to a fourth preferred embodiment of the present invention.

FIG. 17 is a diagram showing an example rotation rate-torque characteristic for the generator used in the third preferred embodiment of the present invention.

FIG. 18 is a diagram showing a structure of a switching control unit.

### DESCRIPTION OF EMBODIMENTS

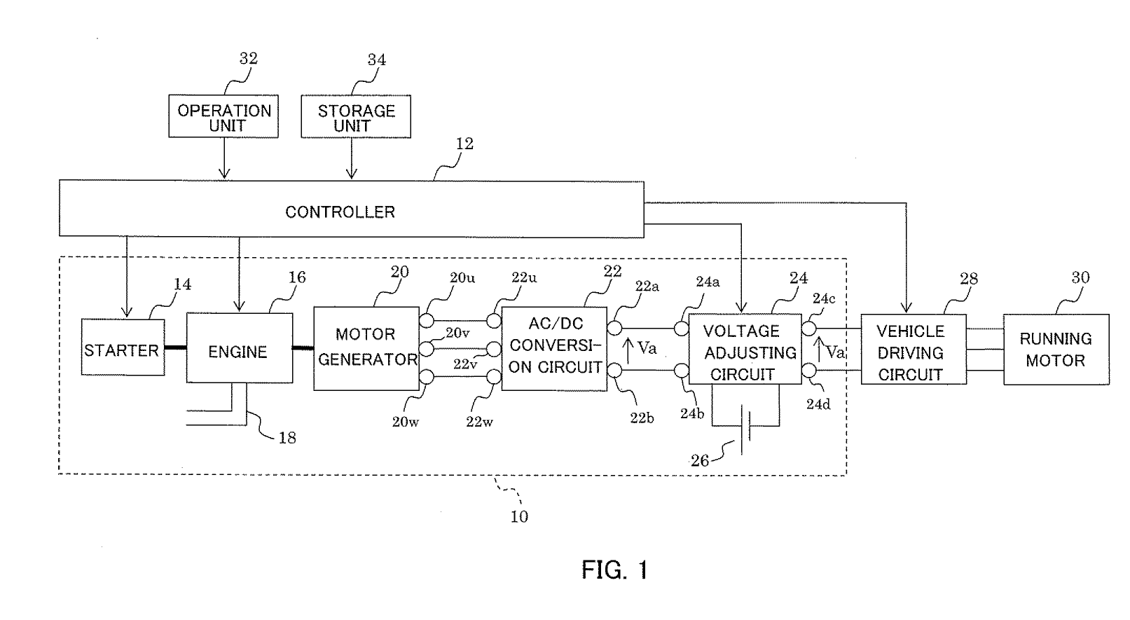

FIG. 1 shows a structure of a series hybrid vehicle driving system according to a first preferred embodiment of the present invention. The series hybrid vehicle driving system comprises a vehicle driving circuit 28 which supplies power to a running motor 30 or recovers generated power from the running motor 30. In addition, the series hybrid vehicle driving system comprises a power generation unit 10 which generates power by driving a motor generator 20 by an engine 16, controls charging and discharging of a secondary battery 26, and supplies and recovers power to and from the vehicle driving circuit 28. The series hybrid vehicle driving system further comprises a controller 12 which controls the vehicle driving circuit 28 and the power generation unit 10 according to a running control of the vehicle, and an operation unit 32 and a storage unit 34 which are used for control of the controller 12.

The vehicle driving circuit 28 converts direct current (DC) power which is output from the power generation unit 10 into alternate current (AC) power according to a control of the controller 12 and outputs the AC power to the running motor 30. The vehicle driving circuit 28 also converts AC power which is output from the running motor 30 into DC power according to a control of the controller 12, and outputs the DC power to the power generation unit 10. Moreover, the vehicle driving circuit 28 adjusts the amount of the power sent and received between the running motor 30 and the power generation unit 10, according to a control of the controller 12. As a circuit having such a function, the vehicle driving circuit 28 may comprise a voltage boosting/reducing circuit which boosts or reduces a DC voltage, an inverter circuit which executes AC/DC conversion, etc.

When the vehicle is to be accelerated, the controller 12 controls the power generation unit 10 and the vehicle driving circuit 28 such that the power is supplied from the power generation unit 10 to the running motor 30. When, on the other hand, the vehicle is to be regeneratively braked, the controller 12 controls the vehicle driving circuit 28 and the power generation unit 10 such that the generated power is supplied from the running motor 30 to the power generation unit 10. This control is executed by adjusting an inter-terminal voltage of power input/output terminals of the running motor 30.

A structure and an operation of the power generation unit 10 will now be described. When power can be supplied from the secondary battery 26 to the vehicle driving circuit 28, the engine 16 and the motor generator 20 may be stopped during the running of the vehicle. The engine 16 and the motor generator 20 start rotating at the start of running of the vehicle or during the running of the vehicle, through the following control.

A starter 14 starts the engine 16 by rotating a shaft of the engine 16 based on a control of the controller 12. At the start of the engine 16, the controller 12 applies a control to the engine 16 with regard to an ignition timing, open/close timing for an exhaust valve and an intake valve, or the like. The engine 16 is supplied with fuel from a fuel supply line 18 according to the output power of the engine 16. The output power of the engine 16 refers to a value obtained by multiplying a number of rotations per unit time of the shaft by torque and a predetermined proportionality constant. At a stage prior to the starting of the engine 16, the starter 14 may rotate the shaft of the engine 16 to adjust the rotational angle of the shaft in advance such that a position of a piston is at a location suitable for starting of the engine 16.

The shaft of the engine 16 is connected to a shaft of the motor generator 20. With this structure, the engine 16 and the motor generator 20 apply torque to each other. The motor generator 20 generates power by the torque of the engine 16 and outputs AC power generated by the power generation to an AC/DC conversion circuit 22. The motor generator 20 may generate single-phase AC power or multi-phase AC power. In this description, the motor generator 20 will be exemplified as one that generates 3-phase AC power.

The AC/DC conversion circuit 22 converts AC power which is output from the motor generator 20 into DC power, and outputs the DC power to a voltage adjusting circuit 24. For the AC/DC conversion circuit 22, there is used a structure having a relationship between an inter-terminal voltage of AC terminals 22u, 22v, and 22w and an inter-terminal voltage of DC terminals 22a and 22b such that when one is increased, the other is increased and when the one is reduced, the other is also reduced.

With the use of such an AC/DC conversion circuit 22, the inter-terminal voltage of the AC terminals 22u, 22v, and 22w of the AC/DC conversion circuit 22; that is, the inter-terminal voltage of power input/output terminals 20u, 20v, and 20w of the motor generator 20 is increased or reduced and the generated power of the motor generator 20 is increased or reduced according to the increase or reduction of the inter-terminal voltage of adjustment output terminals 24a and 24b of the voltage adjusting circuit 24 on the side of the AC/DC conversion circuit 22. With this configuration, the generated power supplied from the motor generator 20 through the AC/DC conversion circuit 22 to the voltage adjusting circuit 24 is controlled according to the increase or reduction of the inter-terminal voltage of the adjustment output terminals 24a and 24b of the voltage adjusting circuit 24.

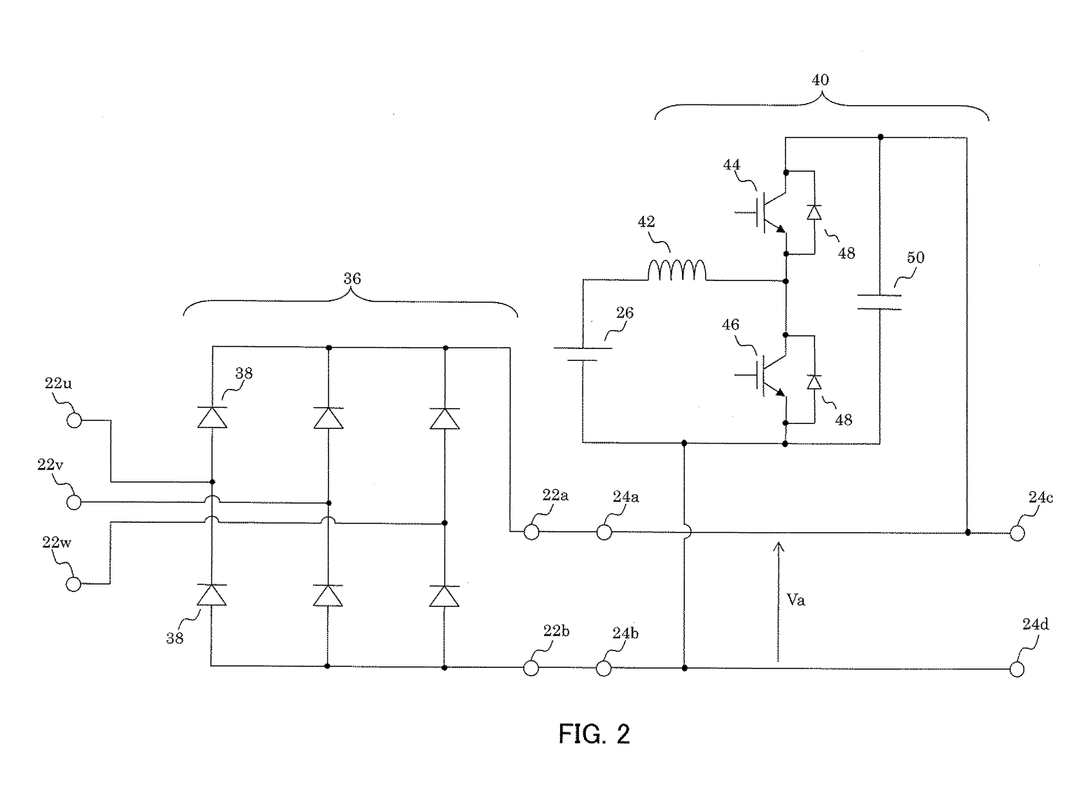

For the AC/DC conversion circuit 22 having such a function, a rectifier circuit 36 as shown in FIG. 2 may be used. The rectifier circuit 36 comprises 6 diodes 38 serving as switching elements.

In the rectifier circuit 36, pairs consisting of upper and lower diodes 38 are provided corresponding to the AC terminals 22u, 22v, and 22w. In each pair of upper and lower diodes 38, an anode terminal of the upper diode 38 is connected to a cathode terminal of the lower diode 38. In addition, a cathode terminal of the upper diode 38 in each pair is connected to the DC terminal 22a and an anode terminal of the lower diode 38 in each pair is connected to the DC terminal 22b. The diode 38 becomes conductive when a voltage is applied such that a potential of the anode terminal is higher than a potential of the cathode terminal. With this structure, the rectifier circuit 36 converts the 3-phase AC power into DC power. That is, in a period where the inter-terminal voltage of the AC terminals 22u, 22v, and 22w exceeds the inter-terminal voltage of the DC terminals 22a and 22b, the rectifier circuit 36 converts the 3-phase AC voltage applied to the AC terminals 22u, 22v, and 22w into a DC voltage by the rectification action of each diode 38, and outputs the DC voltage from the DC terminals 22a and 22b.

In the series hybrid vehicle driving system of the present embodiment, the AC/DC conversion circuit 22 and the voltage adjusting circuit 24 function as a power adjusting unit which adjusts power sent and received between the motor generator 20 and the running motor 30. With this configuration, the generated power of the motor generator 20 and reaction torque applied from the motor generator 20 to the engine 16 are adjusted and the output power of the engine 16 is controlled. This control of the engine 16 is executed in the following manner.

The power adjusting circuit 24 boosts the output voltage of the secondary battery 26 based on a control by the controller 12, and outputs a control voltage Va between the adjustment output terminal 24a and the adjustment output terminal 24b on the side of the AC/DC conversion circuit 22 and between the adjustment output terminal 24c and the adjustment output terminal 24d on the side of the vehicle driving circuit 28. The voltage adjusting circuit 24 adjusts the control voltage Va based on the control of the controller 12.

The voltage adjusting circuit 24 increases the control voltage Va when the output power of the engine 16 is to be increased. When the control voltage Va is increased, the inter-terminal voltage of the power input/output terminals 20u, 20v, and 20w of the motor generator 20 is increased, and a load current flowing in a stator winding of the motor generator 20 is reduced. With this process, a reaction electromagnetic force acting on the shaft of the motor generator 20 is reduced, the reaction torque to the shaft of the engine 16 is reduced, and the output power of the engine 16 is increased.

On the other hand, when the output power of the engine 16 is to be reduced, the voltage adjusting circuit 24 reduces the control voltage Va. When the control voltage Va is reduced, the inter-terminal voltage of the power input/output terminals 20u, 20v, and 20w of the motor generator 20 is reduced, and the load current flowing in the stator winding of the motor generator 20 is increased. With this process, the reaction electromagnetic force acting on the shaft of the motor generator 20 is increased, the reaction torque for the shaft of the engine 16 is increased, and the output power of the engine 16 is reduced.

In the series hybrid vehicle driving system of the present embodiment, the voltage adjusting circuit 24 adjusts the control voltage Va so that the generated power of the motor generator 20; that is, the load power, is controlled, and the output power of the engine 16 is controlled. Therefore, the output power of the engine 16 can be controlled without providing a throttle in the fuel supply line 18 of the engine 16.

A specific example of the output power control of the engine 16 based on adjustment of the control voltage Va will now be described. The series hybrid vehicle driving system comprises the operation unit 32 including an ignition key, an accelerator pedal, a brake pedal, a shift-position lever, and the like. The operation unit 32 outputs drive operation information to the controller 12 based on an operation of the user. The series hybrid vehicle driving system further comprises a unit (not shown) which obtains running information indicating a running state of the vehicle and supplies the running information to the controller 12. The running information includes information such as, for example, a velocity of the vehicle, a rotation rate of the running motor 30, and a voltage and a current inside the vehicle driving circuit 28.

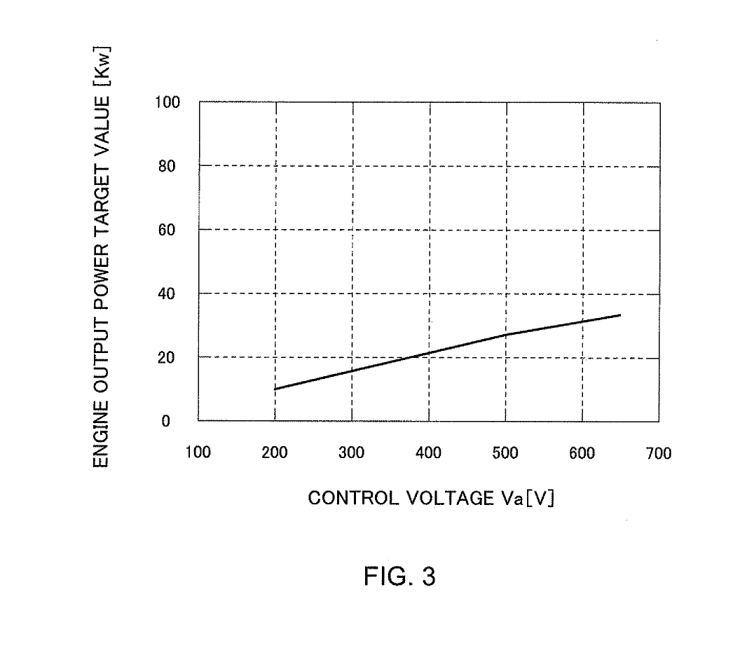

The series hybrid vehicle driving system also comprises the storage unit 34 which stores an engine output power/control voltage table correlating a target value of an engine output power to be output by the engine 16 to the motor generator 20 and the control voltage Va. FIG. 3 shows contents of the engine output power/control voltage table with a graph. The horizontal axis represents the control voltage Va and the vertical axis represents an engine output power target value.

The controller 12 controls the vehicle driving circuit 28 based on the drive operation information and the running information and also determines the engine output power target value. The controller 12 refers to the engine output power/control voltage table stored in the storage unit 34 and determines a value of the control voltage Va correlated to the engine output power target value. The controller 12 controls the voltage adjusting circuit 24 such that the control voltage Va is set to a value determined based on the engine output power/control voltage table.

As the voltage adjusting circuit 24, a voltage boosting/reducing converter circuit 40 as shown in FIG. 2 may be used. The voltage boosting/reducing converter circuit 40 comprises two IGBTs (Insulated Gate Bipolar Transistors) serving as switching elements. Alternatively, for the switching elements, in place of the IGBT, a thyristor, a triac, a general bipolar transistor, a field-effect transistor, or the like may be used. As the secondary battery 26 connected to the voltage adjusting circuit 24, a lithium ion battery, a nickel-cadmium battery, and other energy accumulating devices such as a capacitor may be used. As the capacitor, it is preferable to use an electric double-layer capacitor.

An emitter terminal of an upper IGBT 44 is connected to a collector terminal of a lower IGBT 46. An emitter terminal of the lower IGBT 46 is connected to a negative electrode of the secondary battery 26. Between a collector terminal and the emitter terminal of the upper IGBT 44, a diode 48 is connected with an anode terminal located on the side of the emitter terminal. Between the collector terminal and the emitter terminal of the lower IGBT 46, a diode 48 is connected with an anode terminal located on the side of the emitter terminal.

An output capacitor 50 is connected between the collector terminal of the upper IGBT 44 and the emitter terminal of the lower IGBT 46. The collector terminal of the upper IGBT 44 is connected to the adjustment output terminals 24a and 24c, and the emitter terminal of the lower IGBT 46 is connected to the negative electrode of the secondary battery 26. In addition, the negative electrode of the secondary battery 26 is connected to the adjustment output terminals 24b and 24d.

The controller 12 executes the switching control of the upper IGBT 44 and the lower IGBT 46 based on the following principle, and controls boosting and reducing operations of the voltage.

When the upper IGBT 44 is switched OFF and the lower IGBT 46 is switched ON, current flows from a positive electrode of the secondary battery 26 through an inductor 42 to the collector terminal of the lower IGBT 46. When the lower IGBT 46 is switched OFF in this state, the current flowing through the inductor 42 is stopped, and an induced electromotive power is generated in the inductor 42.

When a voltage obtained by adding the output voltage of the secondary battery 26 and the induced electromotive force is greater than the inter-terminal voltage of the output capacitor 50, the diode 48 becomes conductive. With this process, the output capacitor 50 is charged. Therefore, the output capacitor 50 is charged by a voltage greater than the output voltage of the secondary battery 26, and the inter-terminal voltage of the output capacitor 50 is output between the adjustment output terminals 24a and 24b and between the adjustment output terminals 24c and 24d.

When the voltage obtained by adding the output voltage of the secondary battery 26 and the induced electromotive force is less than the inter-terminal voltage of the output capacitor 50, the diode 48 is set in a non-conductive state. In this case, when the upper IGBT 44 is switched ON, current flows from the output capacitor 50 through the upper IGBT 44 and the inductor 42 to the positive electrode of the secondary battery 26. With this process, charge accumulated in the output capacitor 50 is discharged, the control voltage Va between the adjustment output terminals 24a and 24b and the control voltage Va between the adjustment output terminals 24c and 24d are reduced, and the secondary battery 26 is charged.

When the voltage obtained by adding the output voltage of the secondary battery 26 and the induced electromotive force is equal to the inter-terminal voltage of the output capacitor 50, no current flows to the upper IGBT 44 or the diode 48, the inter-terminal voltage of the output capacitor 50 is maintained, and the control voltage Va between the adjustment output terminals 24a and 24b and the control voltage Va between the adjustment output terminals 24c and 24d are maintained constant.

According to such a circuit operation, the control voltage Va is adjusted such that the control voltage Va reaches the voltage obtained by adding the output voltage of the secondary battery 26 and the induced electromotive force of the inductor 42. The induced electromotive force of the inductor 42 is determined based on the magnitude of the current flowing in the inductor 42 immediately before the lower IGBT 46 is switched OFF. This current is enlarged by elongating the time period during which the lower IGBT is maintained in the ON state and is reduced by shortening the time period during which the lower IGBT 46 is maintained in the ON state. As described above, in order to adjust the control voltage Va, the upper IGBT 44 must be switched ON when the lower IGBT 46 is in the OFF state. Thus, the controller 12 adjusts the control voltage Va by alternately switching the upper IGBT 44 and the lower IGBT 46 ON and OFF.

Next, the control of the running motor 30 by the vehicle driving circuit 28 and the charge/discharge control of the secondary battery 26 by the voltage adjusting circuit 24 will be described. The vehicle driving circuit 28 controls the power sent and received between the voltage adjusting circuit 24 and the running motor 30 under a condition that the control voltage Va is adjusted by the voltage adjusting circuit 24. Specifically, when the vehicle is to be accelerated, the power is supplied from the voltage adjusting circuit 24 to the running motor 30, and, when the vehicle is to be decelerated, the power is supplied from the running motor 30 to the voltage adjusting circuit 24.

The voltage adjusting circuit 24 supplies the power from the secondary battery 26 to the vehicle driving circuit 28 when the power to be supplied to the vehicle driving circuit 28 exceeds the generated power of the motor generator 20. On the other hand, when the power to be supplied to the vehicle driving circuit 28 is less than or equal to the generated power of the motor generator 20, power, among the generated power of the motor generator 20, which is not supplied to the vehicle driving circuit 28 is supplied to the secondary battery 26, to thereby charge the secondary battery 26. In addition, when the generated power of the running motor 30 is supplied from the vehicle driving circuit 28, the voltage adjusting circuit 24 supplies the power to the secondary battery 26, to thereby charge the secondary battery 26.

As described, in the series hybrid vehicle driving system according to the first preferred embodiment of the present invention, the engine 16 is started by the starter 14. By providing the power supply circuit for the motor generator 20, it is possible to use the motor generator 20 as a driving unit of the engine 16, and to have, in the motor generator 20, a function which is similar to that of the starter 14. In a second preferred embodiment of the present invention to be described next, a structure which can supply power from the voltage adjusting circuit 24 to the motor generator 20 is used as the AC/DC conversion circuit 22. The starter 14 used in the series hybrid vehicle driving system of the first preferred embodiment of the present invention is eliminated, and the starting of the engine 16 is executed by the motor generator 20.

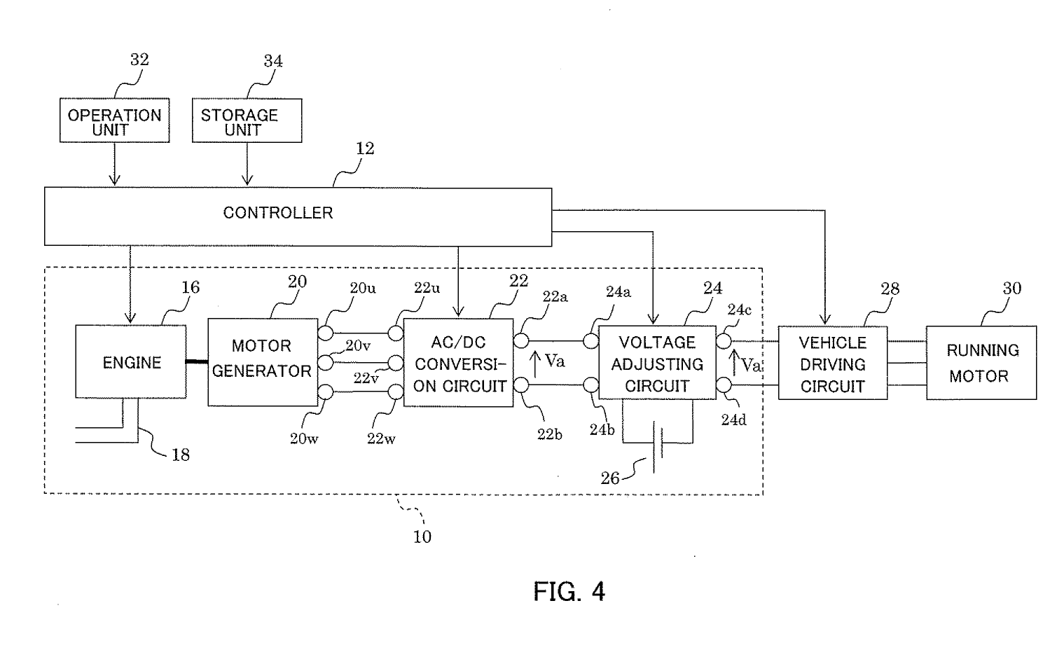

A series hybrid vehicle driving system according to a second preferred embodiment of the present invention will now be described with reference to FIG. 4. Constituting elements similar to those of the series hybrid vehicle driving system of the first preferred embodiment of the present invention will be assigned the same reference numerals and will not be described again.

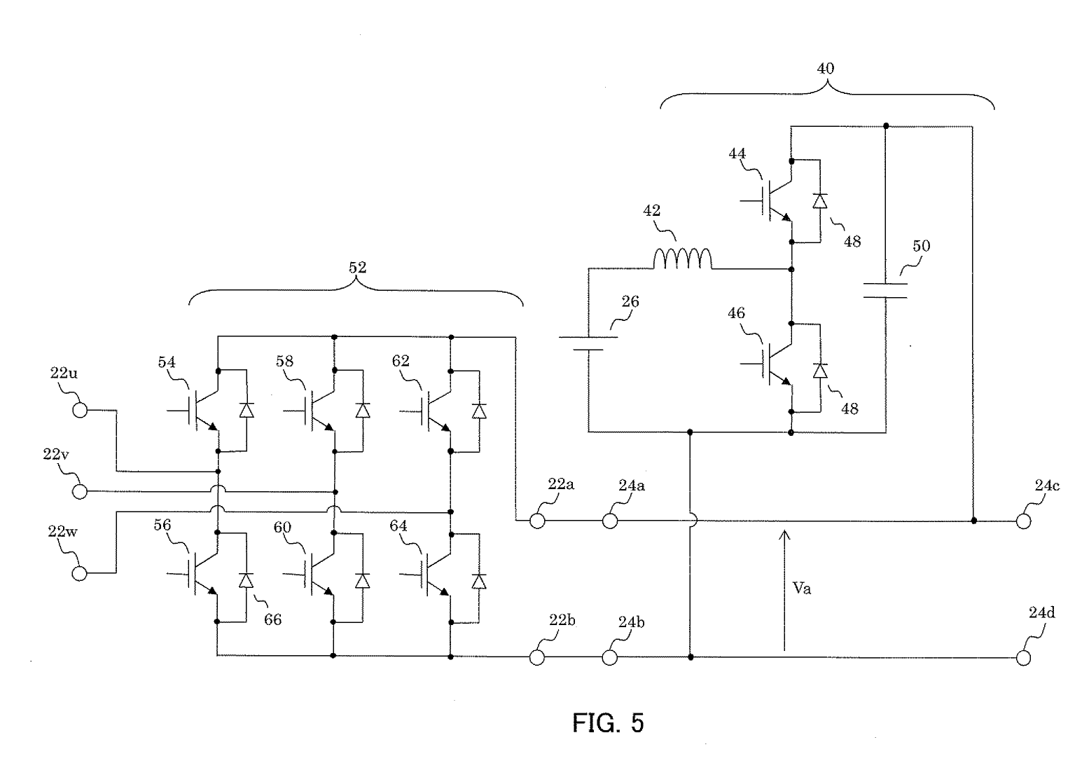

As the AC/DC conversion circuit 22, an inverter circuit 52 as shown in FIG. 5 may be used. The rectifier circuit 36 described above is a conversion circuit which converts the AC power to the DC power. On the other hand, the inverter circuit 52 is a two-way conversion circuit which converts the DC power to the AC power and also converts the AC power to the DC power. The inverter circuit 52 comprises 6 IGBTs (Insulated Gate Bipolar Transistors) serving as switching elements. Alternatively, for the switching elements, in place of the IGBT, a thyristor, a triac, a general bipolar transistor, a field-effect transistor, or the like may be used.

An emitter terminal of an upper IGBT 54 is connected to a collector terminal of a lower IGBT 56. A collector terminal of the upper IGBT 54 is connected to the DC terminal 22a and an emitter terminal of the lower IGBT 56 is connected to the DC terminal 22b. The AC terminal 22u is connected to a connection point between the upper IGBT 54 and the lower IGBT 56.

The inverter circuit 52 also comprises an upper IGBT 58 and a lower IGBT 60 corresponding to the AC terminal 22v. The inverter circuit 52 further comprises an upper IGBT 62 and a lower IGBT 64 corresponding to the AC terminal 22w. The upper and lower IGBTs forming the pair are connected to the DC terminals 22a and 22b and the AC terminals 22v and 22w in a manner similar to the upper IGBT 54 and the lower IGBT 56. In other words, an emitter terminal of the upper IGBT is connected to a collector terminal of the lower IGBT forming the pair, a collector terminal of the upper IGBT is connected to the DC terminal 22a, an emitter terminal of the lower IGBT is connected to the DC terminal 22b, the AC terminal corresponding to the pair of IGBTs is connected to the connection point of the upper GET and the lower IGBT of the pair, and a diode 66 is connected between the collector terminal and the emitter terminal of each IGBT with an anode terminal located at the side of the emitter terminal.

Each IGBT is controlled to be switched ON and OFF by the controller 12 based on a signal applied to a gate terminal. When all IGBTs are in the OFF state, the inverter circuit 52 functions as a rectifier circuit which converts the 3-phase AC power into the DC power. In other words, in the period during which the inter-terminal voltage of the AC terminals 22u, 22v, and 22w exceeds the inter-terminal voltage of the DC terminals 22a and 22b, the inverter circuit 52 converts the 3-phase AC voltage applied to the AC terminals 22u, 22v, and 22w into the DC voltage by the rectifying action of the diodes 66, and outputs the DC voltage from the DC terminals 22a and 22b.

In addition, the inverter circuit 52 controls switching ON and OFF of the IGBTs at a predetermined timing, to convert the DC voltage applied to the DC terminals 22a and 22b into the 3-phase AC voltage, and outputs the same to the AC terminals 22u, 22v, and 22w.

An operation of the series hybrid vehicle driving system according to the second preferred embodiment of the present invention will now be described. As an initial state, the engine 16 and the motor generator 20 are assumed to be stopped. In this case, the IGBTs of the AC/DC conversion circuit 22 are in the OFF state.

With the switching control of the IGBTs, the AC/DC conversion circuit 22 converts the control voltage Va which is output from the voltage adjusting circuit 24 into the 3-phase AC voltage and outputs the 3-phase AC voltage to the motor generator 20. With this process, the motor generator 20 applies torque to the shaft of the engine 16. The engine 16 is started by the torque applied by the motor generator 20. The operation of the power generation unit 10 after the engine 16 is started is similar to that of the first preferred embodiment of the present invention.

According to this structure, no starter for starting the engine 16 is required to be provided on the power generation unit 10. Therefore, the structure of the series hybrid vehicle driving system can be simplified.

In the present embodiment, the power required for starting the engine 16 by the motor generator 20 is in many cases less than a maximum value of the generated power supplied from the motor generator 20 to the power adjusting circuit 24. In this case, the inverter circuit 52 may be an asymmetrical inverter circuit. An asymmetric inverter circuit refers to an inverter circuit where an allowable current value of each IGBT is set lower than the allowable current value of the diode 66.

In the first and second preferred embodiments of the present invention, there are employed structures in which the throttle is not provided in the fuel supply line 18 of the engine 16. However, in order to limit the flow rate of the fuel supplied to the engine 16, a simplified throttle in which the degree of opening of the valve can be adjusted in 2 stages or 3 stages may be provided in the fuel supply line 18. Alternatively, in order to operate the engine 16 in a state where the fuel consumption rate is optimized, it is possible to not remove the throttle. In addition, the power generation unit 10 of the first and second preferred embodiments of the present invention may be used as a so-called EV range extender which is additionally equipped on a power supplying device of an electric vehicle and supplies auxiliary power to the running motor 30.

Moreover, in the first and second preferred embodiments of the present invention, as the voltage adjusting circuit 24, there is described a circuit in which a control voltage Va of the same value is output between the adjustment output terminals 24a and 24b and between the adjustment output terminals 24c and 24d. Alternatively, it is also possible to use a circuit, as the voltage adjusting circuit 24, in which the voltage which is output between the adjustment output terminals 24a and 24b and the voltage which is output between the adjustment output terminals 24c and 24d have values different from each other.

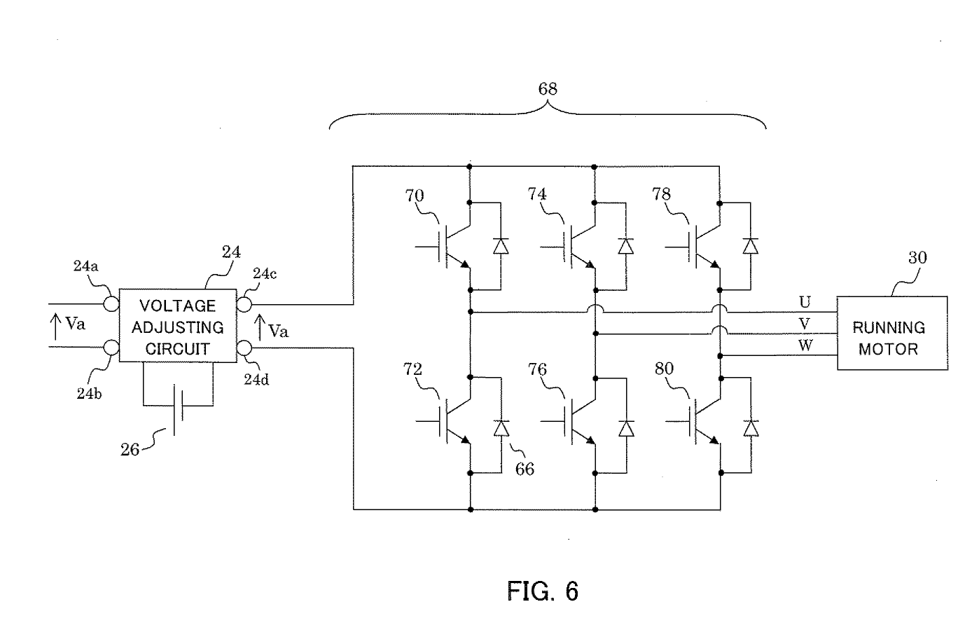

For the vehicle driving circuit 28 in the series hybrid vehicle driving system of FIGS. 1 and 4, a circuit similar to the inverter circuit 52 of FIG. 5 may be used. FIG. 6 shows a circuit structure in this case, along with the voltage adjusting circuit 24 and the running motor 30. Constituting elements similar to those of FIGS. 1 and 4 are assigned the same reference numerals and will not be described again. An inverter circuit 68 comprises 6 IGBTs serving as switching elements. Alternatively, for the switching elements, in place of the IGBT, a thyristor, a triac, a general bipolar transistor, a field-effect transistor, or the like may be used. This is similarly applicable for the IGBTs used in the preferred embodiments of the present invention to be described below.

The inverter circuit 68 comprises an upper IGBT 70 and a lower IGBT 72 corresponding to a U-phase power transmission line of the running motor 30, an upper IGBT 74 and a lower IGBT 76 corresponding to a V-phase power transmission line of the running motor 30, and an upper IGBT 78 and a lower IGBT 80 corresponding to a W-phase power transmission line of the running motor 30. An emitter terminal of the upper IGBT in the upper and lower IGBTs forming a pair is connected to a collector terminal of the lower IGBT of the pair. A collector terminal of the upper IGBT in each pair is connected to the adjustment output terminal 24c, and an emitter terminal of the lower IGBT of each pair is connected to the adjustment output terminal 24d. A power transmission line of a phase corresponding to the pair of IGBTs is connected to a connection point of the upper and lower IGBTs of the pair. A diode 66 is connected between the collector terminal and the emitter terminal of each IGBT with an anode terminal located on the side of the emitter terminal.

Each IGBT is controlled to be switched ON and OFF by the controller 12 based on a signal applied to a gate terminal. When all IGBTs are in the OFF state, the inverter circuit 68 functions as a rectifier circuit which converts the 3-phase AC power into the DC power. Specifically, the inverter circuit 68 rectifies the AC generated voltage of the running motor 30 into the DC voltage, and outputs the DC voltage to the voltage adjusting circuit 24. In addition, the inverter circuit 68 controls the switching ON and OFF of the IGBTs at a predetermined timing, to convert the DC voltage between the adjustment output terminals 24c and 24d into the 3-phase AC voltage, and outputs the 3-phase AC voltage to the running motor 30.

The series hybrid vehicle driving systems of FIGS. 1 and 4 may be configured such that one of an EV mode and an HV mode is selected and the vehicle is driven according to the selected mode. Here, the EV mode refers to a running mode in which the power generation by the motor generator 20 is not executed and the vehicle is driven primarily with the power of the secondary battery 26. The HV mode refers to a running mode in which the vehicle is driven by both the generated power of the motor generator 20 and the power of the secondary battery 26. The selection of the mode may be executed by the controller 12 according to a detection result of an amount of charge in the secondary battery 26. Alternatively, there may be employed a configuration in which, under a condition that the amount of charge in the secondary battery 26 is sufficient, the operation of the controller 12 is set to one of the EV made or the HV mode through an operation of the operation unit 32 by the user.

In either of the EV mode and the HV mode, the vehicle driving circuit 28 controls the power sent and received between the voltage adjusting circuit 24 and the running motor 30 based on the control of the controller 12. However, the process for setting the target value of the control voltage Va differs between the EV mode and the HV mode.

First, the case of the EV mode will be described. When the vehicle is to be accelerated, the controller 12 determines a target value of the control voltage Va as an acceleration control voltage value so that power can be supplied from the voltage adjusting circuit 24 to the running motor 30. The voltage adjusting circuit 24 is controlled such that the control voltage Va is set to the acceleration control voltage value. The controller 12 controls the vehicle driving circuit 28 so that power is supplied from the voltage adjusting circuit 24 to the running motor 30.

When the vehicle is to be regeneratively braked, the controller 12 determines the target value of the control voltage Va as the regenerative control voltage value so that power can be supplied from the running motor 30 to the voltage adjusting circuit 24. The voltage adjusting circuit 24 is controlled such that the control voltage Va is set to the regenerative control voltage value. The controller 12 controls the vehicle driving circuit 28 so that the power is supplied from the running motor 30 to the voltage adjusting circuit 24. In this manner, in the EV mode, the target value of the control voltage Va is determined according to the power sent and received between the voltage adjusting circuit 24 and the running motor 30. When the vehicle driving circuit 28 has a voltage boosting/reducing function, the target value of the control voltage Va may be set to a constant.

On the other hand, in the HV mode, for the target value of the control voltage Va, first, a target lower limit value is set and the target value of the control voltage Va is determined according to the power generation control of the motor generator 20 under a condition that the target value is not lower than the target lower limit value. The target lower limit value is determined as a minimum value for sending and receiving power between the voltage adjusting circuit 24 and the running motor 30. Alternatively, the target lower limit value may be determined according to the running state, the drive operation information which is output from the operation unit 32, or the like. For example, the target lower limit value is set to a larger value for a higher value of the torque to be generated by the running motor 30.

The controller 12 determines a generation power target value of the motor generator 20 based on the running state of the vehicle, a detection value of the amount of charge in the secondary battery 26, the drive operation information which is output from the operation unit 32, or the like. The controller 12 determines the target value of the control voltage Va based on the generation power target value. When the determined target value is greater than or equal to the target lower limit value, the voltage adjusting circuit 24 is controlled such that the control voltage Va reaches the target value. On the other hand, when the determined target value is lower than the lower limit value, the controller 12 controls the voltage adjusting circuit 24 such that the control voltage Va reaches the target lower limit value.

According to such a control, in the HV mode, the target value of the control voltage Va is determined with priority on the control of the motor generator 20 under a condition that the control of the running motor 30 is not affected. With this process, a target value of the control voltage Va suitable for control of the engine 16, the motor generator 20, and the running motor 30 can be easily determined.

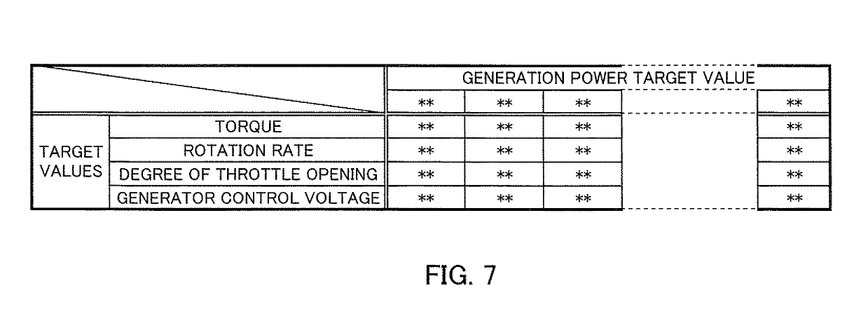

Next, a power generation control employed in the series hybrid vehicle driving systems shown in FIGS. 1 and 4 will be described. In this power generation control, a power generation control table stored in the storage unit 34 and shown in FIG. 7 is used. The power generation control table correlates, to the generation power target value, target values of the torque applied from the engine 16 to the motor generator 20, the rotation rate of the motor generator 20, a degree of throttle opening of the engine 16, and the generator control voltage (control voltage Va) The generator control voltage refers to the same voltage as the control voltage Va described above.

As will be described below, the power generation control table is created to optimize the fuel consumption rate of the engine 16 assuming that the engine 16 and the motor generator 20 are each configured to satisfy a predetermined condition for a respective rotation rate-torque characteristic.

The controller 12 determines the generation power target value for the motor generator 20 based on the running state of the vehicle and the drive operation information which is output from the operation unit 32. The controller 12 refers to the power generation control table, to obtain target values for the torque, rotation rate, degree of throttle opening, and generator control voltage corresponding to the generation power target value. The controller 12 controls the voltage adjusting circuit 24 and the throttle of the engine 16 such that the torque applied from the engine 16 to the motor generator 20, the rotation rate of the motor generator 20, the degree of opening of the throttle of the engine 16, and the generator control voltage reach the target values.

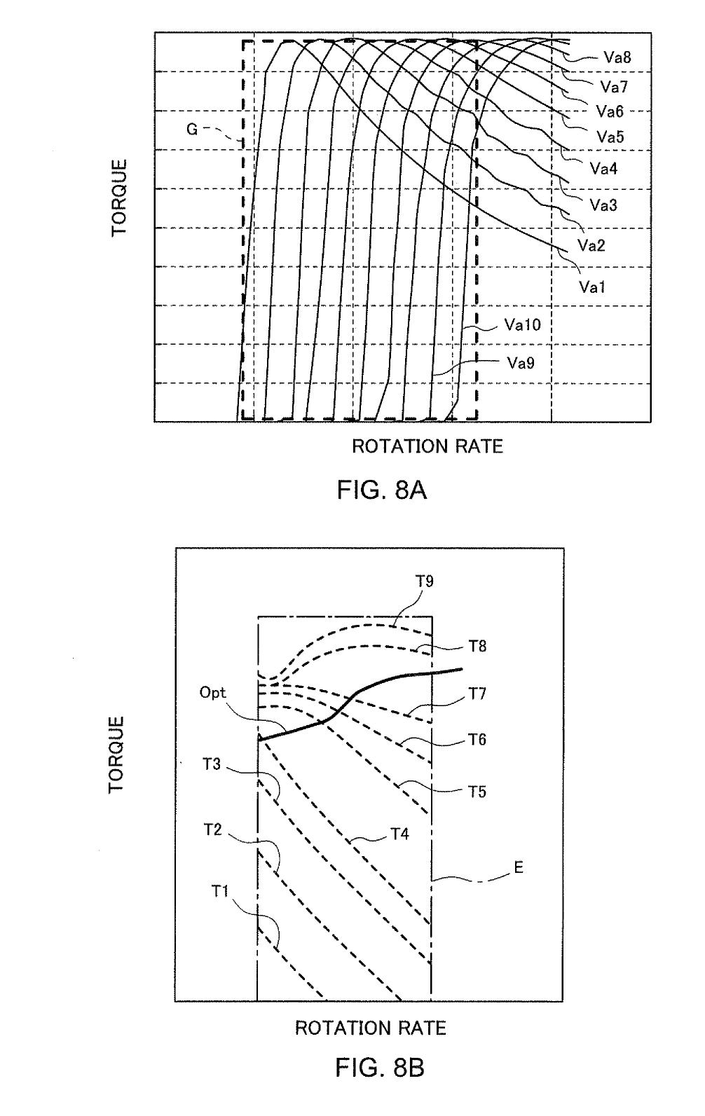

A method of creating the power generation control table based on the rotation rate-torque characteristics for the engine 16 and the motor generator 20 will now be described. FIG. 8A shows an example rotation rate-torque characteristic for the motor generator 20. The horizontal axis represents the rotation rate, and the vertical axis represents the torque applied from the engine 16. FIG. 8A shows a relationship between the rotation rate and the torque for each of cases where the generator control voltage is set to a constant among voltages Va1-Va10. That is, the generator control voltage is a parameter. The generator control voltages Va1-Va10 are in a relationship of Va1<Va2< . . . <Va10.

Under the condition that the generator control voltage is constant, an upper limit is created for the torque applied from the engine 16 to the motor generator 20. Thus, when the rotation rate is to be increased, the torque is increased with the increase in the rotation rate, and, after the torque has reached the upper limit, the torque is reduced with the increase in the rotation rate. In the present embodiment, the motor generator 20 is operated in a range where the torque is increased with the increase in the rotation rate. For the motor generator 20, as shown by a dotted line in FIG. 8A, a generator operation range G is determined as a range of possible torque and possible rotation rate during running of the vehicle. However, in the range shown by the dotted line in FIG. 8A, the values on the characteristic curve where the torque is reduced with the increase in the rotation rate are not used for the power generation control.

FIG. 8B shows a rotation rate-torque characteristic for the engine 16. FIG. 88 shows a general relationship between the rotation rate and the torque with the degree of throttle opening serving as a parameter. For each of the cases where the degree of throttle opening is set to a constant among T1-T9, a relationship between the rotation rate and the torque is shown with a dotted line. Here, there is a relationship that T1<T2< . . . <T9. A curve shown by a solid line Opt in FIG. 8B is an optimum fuel consumption line indicating that the fuel consumption rate of the engine 16 is at the minimum. For the engine 16, as shown by a dot-and-chain line in FIG. 88, an engine operation range E is determined as a range of possible torque and possible rotation rate during running of the vehicle.

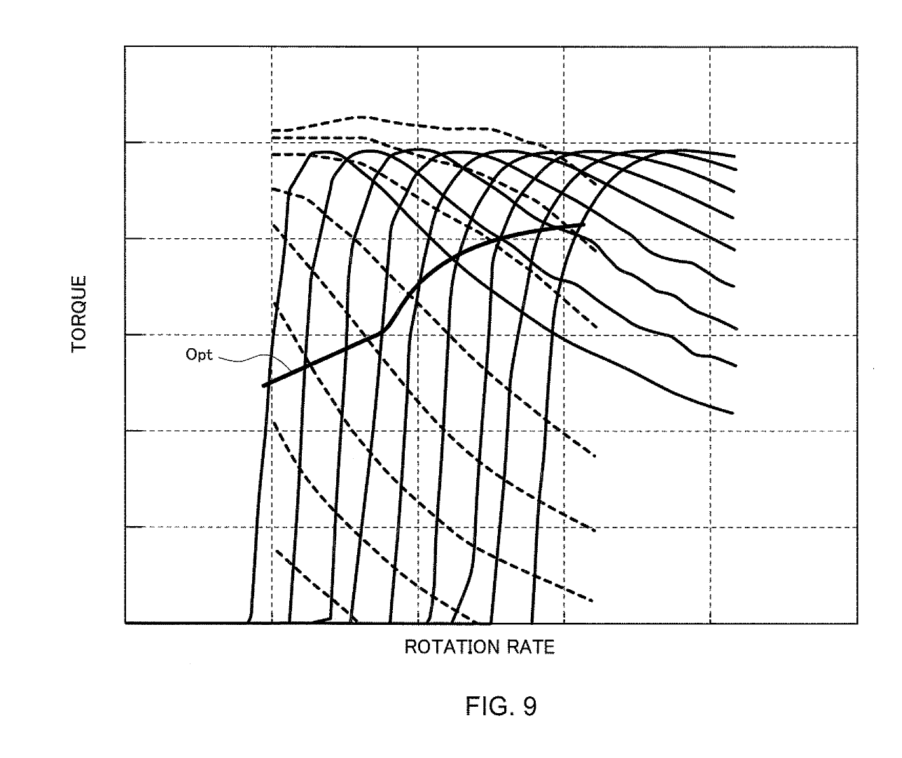

In the present embodiment, the engine 16 and the motor generator 20 are configured such that the engine operation range E and the generator operation range G overlap each other. FIG. 9 shows the rotation rate-torque characteristics for the engine 16 and the motor generator 20 in an overlapping manner for such a case. The power generation control table of FIG. 7 is created in the following mariner based on the rotation rate-torque characteristic in which the engine operation range E and the generator operation range G are overlapped.

The target values for the rotation rate and the torque in the power generation control table are determined in the rotation rate-torque characteristic shown in FIG. 9 as a coordinate of an intersection between an inverse proportional curve represented by T=P/(N×π/30) (where P is a constant) and the optimal fuel consumption line Opt. Here, T represents the torque, P represents the generation power target value, and N represents the rotation rate. That is, the coordinate of the intersection between the inverse proportional curve represented by T=P/(N×π/30) and the optimal fuel consumption line represents the target values of the rotation rate and the torque corresponding to the generation power target value P. The target values for the degree of throttle opening and the generator control voltage in the power generation control table are determined from the value of the parameter in the intersection coordinate determined in this way.

With the control using the power generation control table, when the generation power target value is given, the target values for torque, rotation rate, degree of throttle opening, and generator control voltage which can minimize the fuel consumption rate of the engine 16 are obtained, and a control to minimize the fuel consumption rate of the engine 16 can be executed using the target values.

In the above description, there has been shown an example configuration in which the engine operation range E and the generator operation range G are overlapped, with the rotation rate of the engine 16 and the rotation rate of the motor generator 20 assumed to be equal to each other. In a case where a torque transmission mechanism for transmitting torque with a predetermined rotational ratio is provided between the engine 16 and the motor generator 20, the rotation rate in one of the operation ranges may be converted to the rotation rate of the other operation range by the rotation ratio, and, then, the operation ranges may be overlapped.

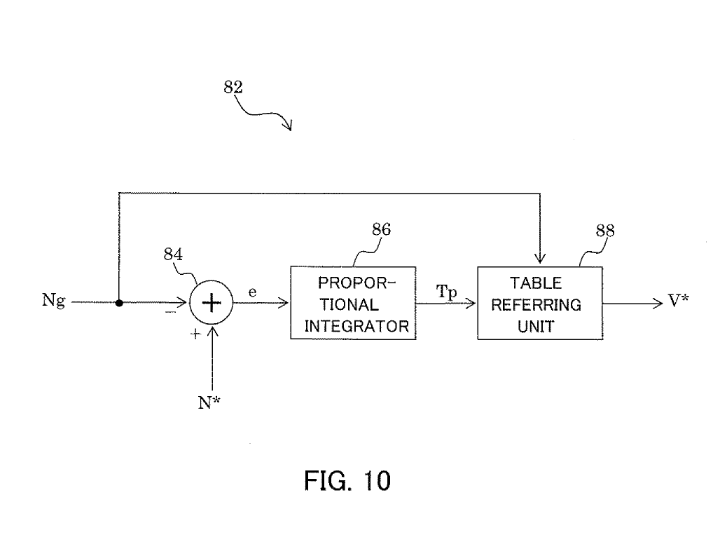

Next, a rotational state control used in the series hybrid vehicle driving system shown in FIGS. 1 and 4 will be described. In this rotational state control, a control voltage calculating unit 82 shown in FIG. 10 provided inside the controller 12 is used. The control voltage calculating unit 82 determines a torque target value Tp by a proportional integration calculation with respect to a difference between a detection value Ng of the rotation rate of the motor generator 20 and a target value N* of the rotation rate of the motor generator 20. Based on the torque target value Tp and the rotation rate detection value Ng of the motor generator 20, the target value V* of the generator control voltage is determined. The controller 12 controls the voltage adjusting circuit 24 such that the generator control voltage reaches the target value V*.

The control voltage calculating unit 82 comprises an adder 84, a proportional integrator 86, and a table referring unit 88. The adder 84 adds a value in which the polarity of the rotation rate detection value Ng of the motor generator 20 is inverted and the target value N* of the rotation rate of the motor generator 20, to determine a difference between these values as an instruction value e, and outputs the instruction value e to the proportional integrator 86. The proportional integrator 86 determines a torque target value Tp based on a proportional integration calculation on the instruction value e. The table referring unit 88 refers to a voltage determination table stored in the storage unit 34, obtains a target value of the generator control voltage corresponding to the torque rotation rate detection value Ng and the torque target value N* of the motor generator 20 as the control voltage target value V*, and outputs the control voltage target value V*.

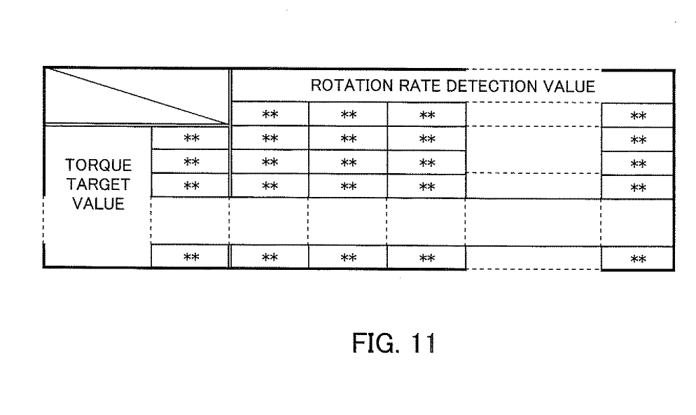

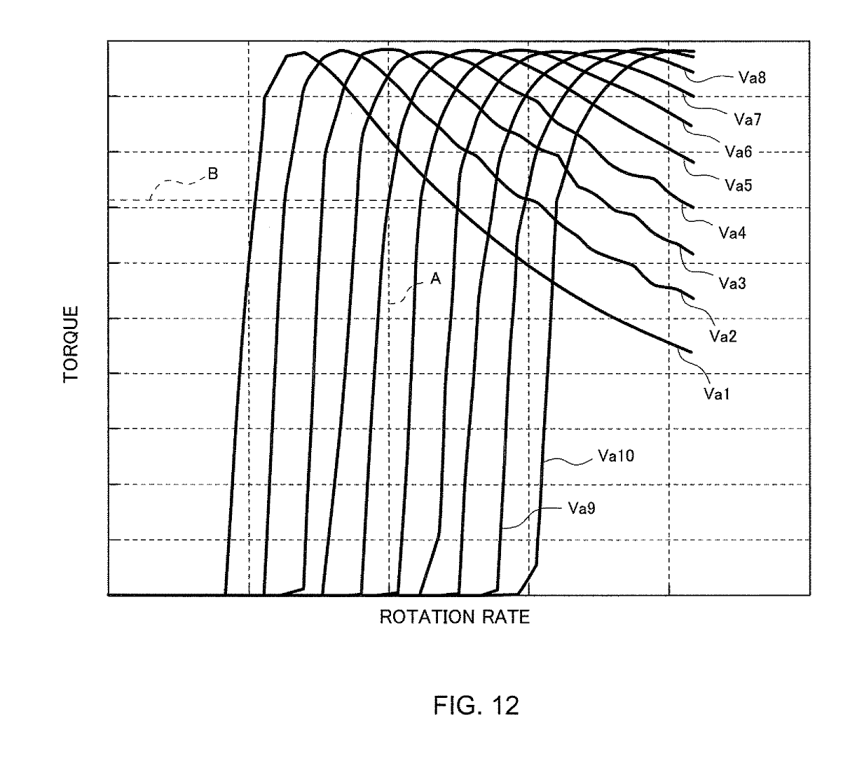

FIG. 11 shows the voltage determination table. The voltage determination table correlates a control voltage target value to the rotation number detection value and the torque target value. The voltage determination table is created based on the rotation rate-torque characteristic for the motor generator 20. More specifically, in the generator operation range in the rotation rate-torque characteristic shown in FIG. 12, one control voltage target value is determined for one rotation rate detection value and one torque target value. For example, when a straight line A indicating the rotation rate detection value and a straight line B indicating the torque target value are drawn on the rotation rate-torque characteristic, a generator control voltage corresponding to the rotation rate-torque characteristic curve passing through the intersection of these straight lines is the control voltage target value corresponding to the rotation rate detection value and the torque target value. In the example configuration of FIG. 12, the control voltage target value is Va5. In this manner, the voltage determination table is created by determining the control voltage target value based on the rotation rate-torque characteristic.

According to the rotational state control by the control voltage calculating unit 82, the rotational state of the motor generator 20 can be controlled according to a unique rotation rate-torque characteristic for the motor generator 20.

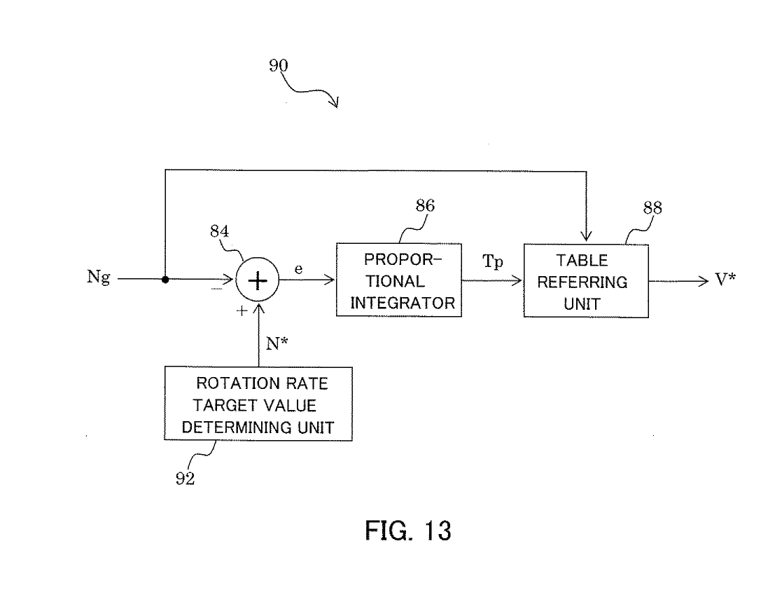

The rotational state control described herein may be used for a rotational control of stopping the engine. FIG. 13 shows a structure of a control voltage calculating unit 90 for executing the engine stop rotation control. Constituting elements similar to those shown in FIG. 10 are assigned the same reference numerals and will not be described again. The control voltage calculating unit 90 is a unit in which a rotation rate target value determining unit 92 for determining a rotation rate target value of the motor generator 20 is provided on the control voltage calculating unit 82. The rotation rate target value determining unit 92 outputs a rotation rate target value N* having the value which changes according to elapsed time after the start of the engine stop rotation control. The control voltage calculating unit 90 determines a torque target value Tp by a proportional integration calculation on a difference between the rotation rate detection value Ng and the rotation rate target value N*, and determines a control voltage target value V* based on the torque target value Tp and the rotation rate detection value Ng. The controller 12 controls the voltage adjusting circuit 24 such that the generator control voltage reaches the control voltage target value V*.

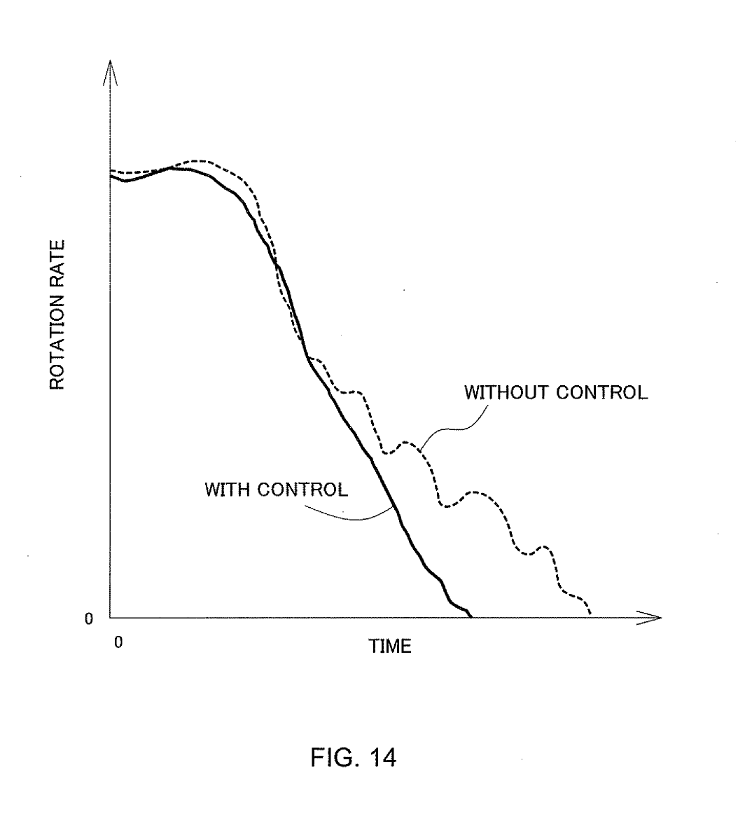

FIG. 14 shows, with a solid line, a temporal change of the rotation rate when the engine stop rotation control is executed and, with a dotted line, a temporal change of the rotation rate when the engine stop rotation control is not executed. The horizontal axis represents time with respect to a reference at a timing when the engine stop rotation control is started, and the vertical axis represents the rotation rate. When the engine stop rotation control is not executed, a crank vibration occurs in the engine shaft and the rotation rate is changed. The crank vibration may affect the ride quality. By executing the engine stop rotation control, the change in the rotation rate can be inhibited and the ride quality can be improved. In addition, the time from the start of the engine stop rotation control to the stopping of the engine shaft can be shortened.

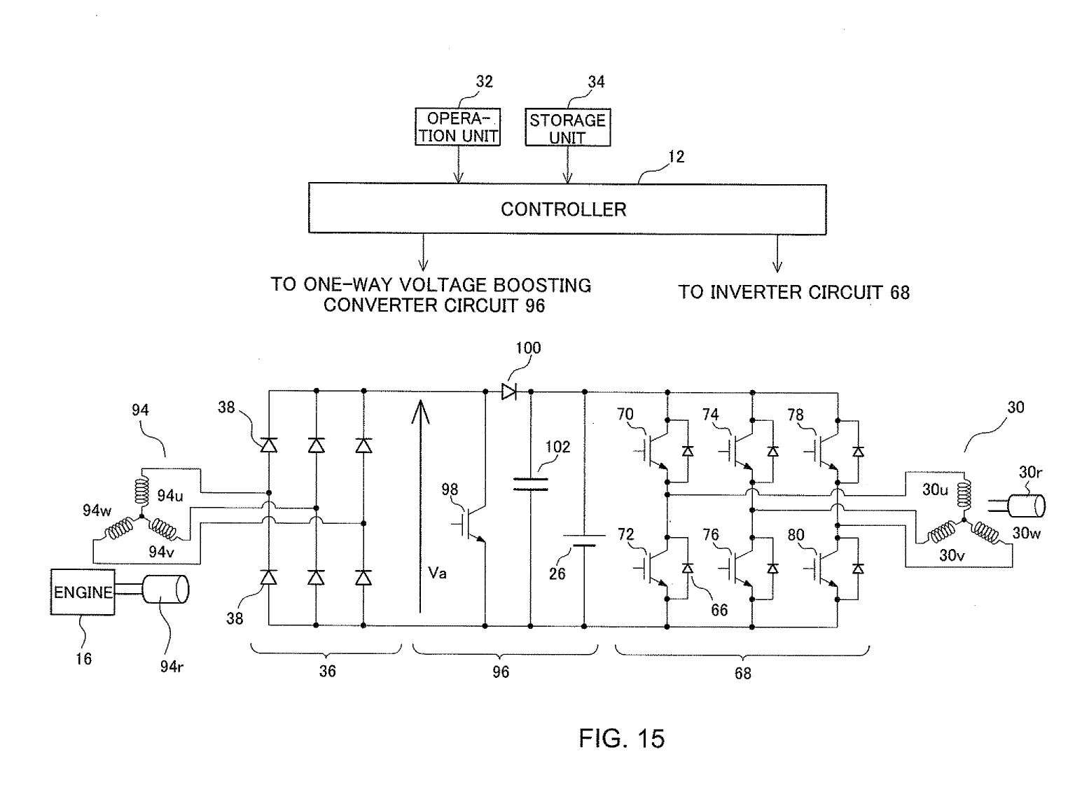

FIG. 15 shows a structure of a series hybrid vehicle driving system according to a third preferred embodiment of the present invention. Constituting elements similar to those shown in FIGS. 1, 2, 4, and 6 are assigned the same reference numerals and will not be described again. In the present embodiment, a generator 94 corresponding to the motor generator 20 described above is shown with a rotor 94r and 3-phase generator field windings 94u, 94v, and 94w, and the running motor 30 is shown with a rotor 30r and 3-phase motor field winding 30u, 30v, and 30w.

As the AC/DC conversion circuit, the rectifier circuit 36 similar to the circuit shown in FIG. 2 is used. As the voltage adjusting circuit, a one-way voltage boosting converter circuit 96 is used. As the vehicle driving circuit, the inverter circuit 68 similar to the circuit shown in FIG. 6 is used.

Each of the generator field windings 94u, 94v, and 94w has one terminal commonly connected to the other commonly connected terminals at a neutral point. The other terminal of each of the generator field windings 94u, 94v, and 94w is connected to a connection point of the pair of upper and lower diodes 38 corresponding to each phase in the rectifier circuit 36. Each of the motor field windings 30u, 30v, and 30w has one terminal commonly connected to the other commonly connected terminals at a neutral point. The other terminal of each of the motor field windings 30u, 30v, and 30w is connected to the connection point of the pair of upper and lower IGBTs corresponding to each phase in the inverter circuit 68.

The one-way voltage boosting converter circuit 96 comprises an IGBT 98, a diode 100, an output capacitor 102, and the secondary battery 26. A collector terminal of the IGBT 98 is connected to a cathode terminal of each upper diode 38 of the rectifier circuit 36, and an emitter terminal of the IGBT 98 is connected to an anode terminal of each lower diode 38 of the rectifier circuit 36. An anode terminal of the diode 100 is connected to the collector terminal of the IGBT 98, and a cathode terminal of the diode 100 is connected to one terminal of the output capacitor 102. The other terminal of the output capacitor 102 is connected to the emitter terminal of the IGBT 98. The positive electrode of the secondary battery 26 is connected to the cathode terminal of the diode 100, and the negative electrode of the secondary battery 26 is connected to the emitter terminal of the IGBT 98.

The generator 94 operates such that the generated voltage in each generator winding is lower than the output voltage of the secondary battery 26. Switching of the IGBT 98 is controlled by the controller 12. When the IGBT 98 is in the ON state, current flows from the generator field winding through the rectifier circuit 36 to the IGBT 98 according to the generated voltage in the generator field winding. In addition, current flows through the IGBT 98 in a direction from the collector terminal to the emitter terminal. When the IGBT 98 is switched OFF in this state, the induced electromotive force generated in the generator field winding is added to the generated voltage, and this voltage appears between the collector terminal and the emitter terminal of the IGBT 98. With this process, the voltage in which the induced electromotive force is added to the generated voltage is applied through the diode 100 to the output capacitor 102, the secondary battery 26, and the inverter circuit 68.

With such a configuration, by adjusting the switching timing of the IGBT 98, it is possible to control the voltage between the collector terminal and the emitter terminal of the IGBT 98 as the generator control voltage Va. With this configuration, the engine 16 and the generator 94 can be controlled. In addition, because a voltage is applied to the inverter circuit 68 by the secondary battery 26, even if the generator control voltage Va is changed, the change in the voltage applied to the inverter circuit 68 is small. With this structure, the generator control voltage Va can be controlled independently from the voltage applied to the inverter circuit 68, and the engine 16 and the generator 94 can be easily controlled.

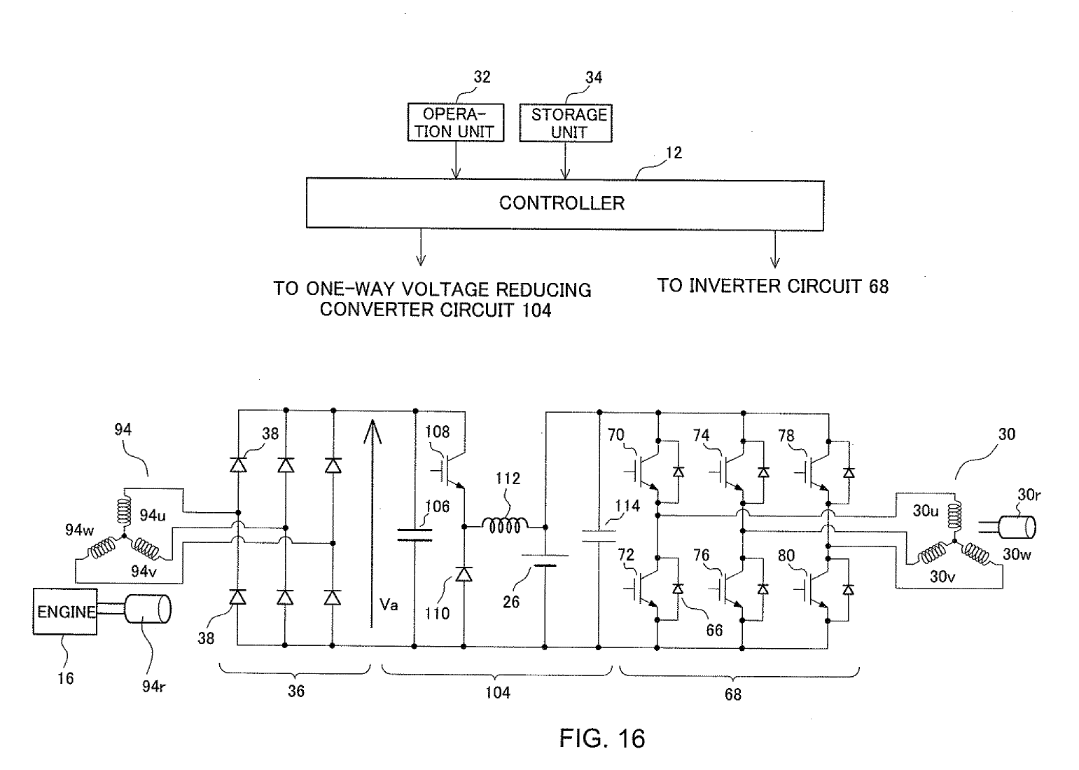

FIG. 16 shows a structure of a series hybrid vehicle driving system according to a fourth preferred embodiment of the present invention. Constituting elements similar to those shown in FIG. 15 are assigned the same reference numerals and will not be described again.

In the present embodiment, the one-way voltage boosting converter circuit 96 in the third preferred embodiment is replaced with a one-way voltage reducing converter circuit 104. The one-way voltage reducing converter circuit 104 comprises a high voltage side capacitor 106, an IGBT 108, a diode 110, a voltage reducing inductor 112, a low voltage side capacitor 114, and the secondary battery 26. The high voltage side capacitor 106 is connected between a cathode terminal of each upper diode 38 of the rectifier circuit 36 and an anode terminal of each lower diode 38 of the rectifier circuit 36. A collector terminal of the IGBT 108 is connected to a cathode terminal of each upper diode 38 of the rectifier circuit 36, and an emitter terminal of the IGBT 108 is connected to a cathode terminal of the diode 110. An anode terminal of the diode 110 is connected to an anode terminal of each lower diode 38 of the rectifier circuit 36. One terminal of the voltage reducing inductor 112 is connected to a connection point between the IGBT 108 and the diode 110, and the other terminal of the voltage reducing inductor 112 is connected to the positive electrode of the secondary battery 26. The negative electrode of the secondary battery 26 is connected to the anode terminal of the diode 110. The low voltage side capacitor 114 is connected between the positive electrode and the negative electrode of the secondary battery 26.

The generator 94 operates such that the generated voltage in each generator winding is greater than the output voltage of the secondary battery 26. Switching of the IGBT 108 is controlled by the controller 12. When the IGBT 108 is in the ON state, current flows from the generator field winding through the rectifier circuit 36 and the IGBT 108 to the voltage reducing inductor 112. When the IGBT 108 is switched OFF in this state, an induced electromotive force appears in the voltage reducing inductor 112. With this process, the induced electromotive force of the voltage reducing inductor 112 is applied through the diode 110 to the secondary battery 26, the low voltage side capacitor 114, and the inverter circuit 68. On the other hand, when the IGBT 108 is switched OFF, the induced electromotive force of the generator field winding and the generated voltage are applied between the terminals of the high voltage side capacitor 106 as an inverter control voltage Va.

According to such a configuration, by adjusting the switching timing of the IGBT 108, it is possible to control the inter-terminal voltage of the high voltage side capacitor 106 as the generator control voltage Va. With this process, the engine 16 and the generator 94 can be controlled. In addition, because a voltage is applied to the inverter circuit 68 by the secondary battery 26, even when the generator control voltage Va is changed, a change in the voltage Va applied to the inverter circuit 68 is small. With this configuration, the generator control voltage can be controlled independently from the voltage applied to the inverter circuit 68, and the engine 16 and the generator 94 can be easily controlled.

A difference between the generators 94 used in the third and fourth preferred embodiments will now be described. As described above, the generator 94 in the third preferred embodiment operates such that the generated voltage in each generator winding is lower than the output voltage of the secondary battery 26 and the generator 94 in the fourth preferred embodiment operates such that the generated voltage in each generator winding is greater than the output voltage of the secondary battery 26. Therefore, in the third and fourth preferred embodiments, generators 94 having different rotation rate-torque characteristics are used.

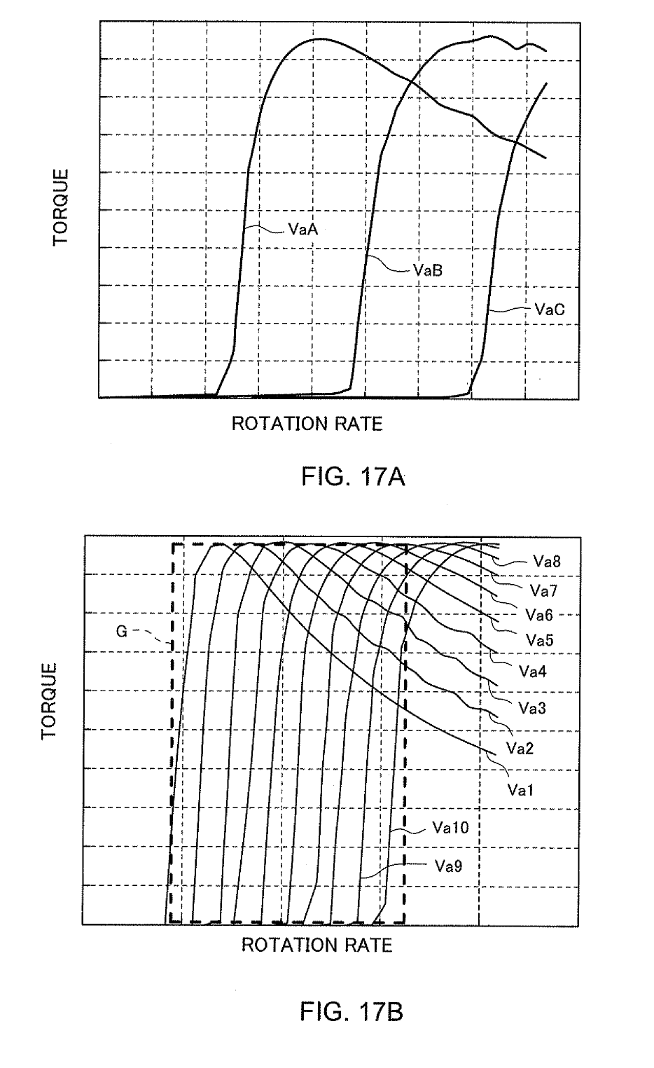

FIG. 17A exemplifies the rotation rate-torque characteristic for the generator 94 used in the third preferred embodiment. VaA, VaB, and VaC are generator control voltages serving as a parameter, which are in a relationship of VaA<VaB<VaC<V_{batt}. Here, V_{batt} represents the voltage of the secondary battery 26. FIG. 17B exemplifies the rotation rate-torque characteristic for the generator 94 used in the fourth preferred embodiment.

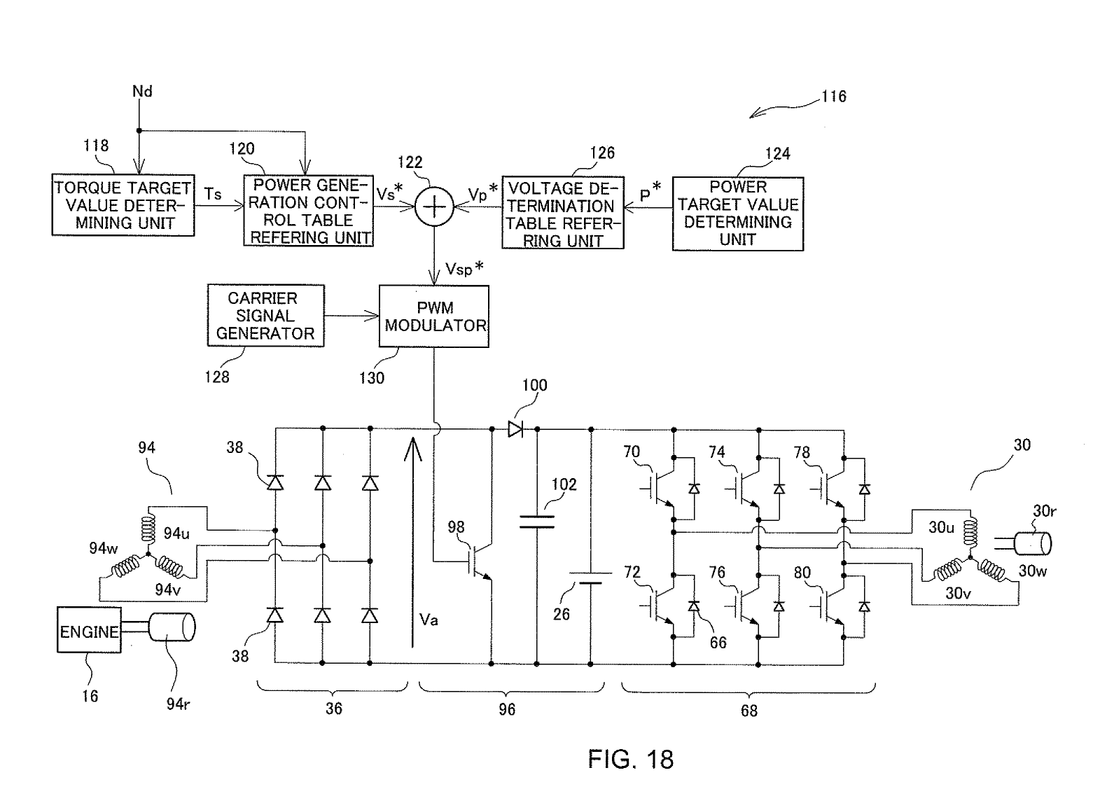

Next, a generator damping control used in the third and fourth preferred embodiments will be described. In this control, the rotational vibration of the generator 94 is inhibited. The generator vibration may be caused by vibration of the engine body, and, by inhibiting the generator vibration, in many cases, it is possible to inhibit the vibration of the engine body and to improve the ride quality. FIG. 18 shows a structure of a switching control unit 116 which executes the generator damping control. Constituting elements similar to those shown in FIG. 15 are assigned the same reference numerals and will not be described again. The switching control unit 116 comprises a torque target value determining unit 118, a power generation control table referring unit 120, an adder 122, a power target value determining unit 124, a voltage determination table referring unit 126, a carrier signal generator 128, and a PWM modulator 130, and is formed inside the controller 12. In FIG. 18, the circuit structure for the third preferred embodiment is shown, but the present control can be applied to the circuit structure of the fourth preferred embodiment. In addition, the engine 16 and the generator 94 are formed such that the engine operation range and the generator operation region in the rotation rate-torque characteristic overlap each other.

The torque target value determining unit 118 determines a torque target value Ts for inhibiting the rotational vibration of the rotor 94r based on the rotation rate detection value Ng of the generator 94. This calculation is executed by a well-known control technique using the rotation rate detection value. The voltage determination table referring unit 126 obtains the torque target value Ts determined by the torque target value determining unit 118 and the rotation rate detection value Ng of the generator 94. The voltage determination table referring unit 126 refers to the voltage determination table stored in the storage unit 34 and shown in FIG. 11, to obtain a control voltage target value, and outputs the control voltage target value to the adder 122 as a vibration inhibition target value Vs*.

Meanwhile, the power target value determining unit 124 determines the generation power target value P* of the generator 94 based on the running state and the drive operation information. The power generation control table referring unit 120 obtains the generation power target value P* determined by the power target value determining unit 124. The power generation control table referring unit 120 refers to the power generation control table stored in the storage unit 34 and shown in FIG. 7, to obtain the control voltage target value, and outputs the control voltage target value to the adder 122 as a running control target value Vp*. The adder 122 adds the vibration inhibition target value Vs* and the running control target value Vp* and outputs the added value to the PWM modulator 130 as a vibration inhibition/running target value Vsp*.

The carrier signal generator 128 outputs a carrier signal having a temporal waveform such as a triangular waveform and a saw tooth waveform. The PWM modulator 130 generates a PWM modulation signal based on the carrier signal and the vibration inhibition/running target value Vsp*. The PWM modulation signal is a rectangular wave signal in which the duty ratio is determined according to a time length in one period of the carrier signal in which the value of the carrier signal is greater than or equal to the vibration inhibition/running target value Vsp*. The PWM modulator 130 controls the IGBT 108 to be switched ON and OFF by the duty ratio indicated by the PWM modulation signal. With this configuration, the one-way voltage boosting converter circuit 96 is controlled such that the generator control voltage Va reaches the vibration inhibition/running target value Vsp*.

According to the generator damping control, a torque target value for inhibiting the rotational vibration of the rotor 94r is determined, and the generator control voltage is controlled based on the torque target value. In this manner, the ride quality of the vehicle can be improved.

What is claimed is:

1. A power generation device equipped on a vehicle, comprising:
an engine which generates torque by combustion of fuel;
a generator wherein the engine and the generator apply torque to each other;
a power adjusting unit to which the generator is connected, and which sends and receives power to and from a vehicle driving unit that drives the vehicle with the power and which adjusts the power sent to and received from the vehicle driving unit; and
a target drive state determining unit which determines a target drive state of the engine according to a control state of the vehicle, wherein
the power adjusting unit comprises:
a conversion circuit which converts alternate current power generated by the generator into direct current power and outputs the direct current power to a power path to the vehicle driving unit; and
a voltage adjusting circuit which adjusts a direct current transmission voltage which is transmitted to the power path between the conversion circuit and the vehicle driving unit, and
the voltage adjusting circuit adjusts the direct current transmission voltage according to the target drive state.

2. The power generation device equipped on a vehicle according to claim 1, wherein
the voltage adjusting circuit comprises:
an electricity accumulating unit which can be repeatedly charged and discharged, and
a voltage boosting/reducing converter circuit which converts a voltage between the direct current transmission voltage and an output voltage of the electricity accumulating unit.

3. The power generation device equipped on a vehicle according to claim 1, further comprising:
a reverse direction conversion circuit which converts direct current power into alternate current power, wherein
the reverse direction conversion circuit converts direct current power based on the direct current transmission voltage into alternate current power, and outputs the alternate current power to a power path to the generator, so that the generator causes the engine to start.

4. The power generation device equipped on a vehicle according to claim 2, further comprising:
a reverse direction conversion circuit which converts direct current power into alternate current power, wherein
the reverse direction conversion circuit converts direct current power based on the direct current transmission voltage into alternate current power, and outputs the alternate current power to a power path to the generator, so that the generator causes the engine to start.

5. A power generation device equipped on a vehicle, comprising:
an engine which generates torque by combustion of fuel;
a generator wherein the engine and the generator apply torque to each other; and
a power adjusting unit to which the generator is connected, and which sends and receives power to and from a vehicle driving unit that drives the vehicle with the power and which adjusts the power sent to and received from the vehicle driving unit, wherein
the power adjusting unit comprises:
a conversion circuit which converts alternate current power generated by the generator into direct current power and outputs the direct current power to a power path to the vehicle driving unit; and
a voltage adjusting circuit which adjusts a direct current transmission voltage which is transmitted to the power path between the conversion circuit and the vehicle driving unit,
the generator operates in a generator operation range in a rotation rate-torque characteristic in which torque applied to the generator increases with an increase in a rotation rate of the generator under a condition that the direct current transmission voltage is constant, and
a rotation rate-torque characteristic for the engine is set such that an engine operation range in the rotation rate-torque characteristic overlaps the generator operation range.

6. The power generation device equipped on vehicle according to claim 5, further comprising:
a controller which determines operation conditions of the engine and the generator based on torque applied to the generator and a rotation rate of the generator corresponding to a generation power target value, rotation rate-torque characteristics for the engine and the generator in an overlapping range of the generator operation range and the engine operation range, and an optimum fuel consumption rate characteristic for the engine in the overlapping range, and controls the engine and the generator based on the operation conditions.

7. A power generation device equipped on a vehicle, comprising:
an engine which generates torque by combustion of fuel;
a generator wherein the engine and the generator apply torque to each other;
a power adjusting unit to which the generator is connected, and which sends and receives power to and from a vehicle driving unit that drives the vehicle with the power and which adjusts the power sent to and received from the vehicle driving unit; and
a controller which controls the power adjusting unit, wherein
the power adjusting unit comprises:
a conversion circuit which converts alternate current power generated by the generator into direct current power and outputs the direct current power to a power path to the vehicle driving unit; and
a voltage adjusting circuit which adjusts a direct current transmission voltage which is transmitted to the power path between the conversion circuit and the vehicle driving unit, and
the controller comprises:
a correlating unit which correlates a rotation rate detection value of the generator, a target value of torque applied to the generator, and a target value of the direct current transmission voltage based on a rotation rate-torque characteristic for the generator with the direct current transmission voltage as a parameter; and
a voltage adjusting circuit controlling unit which determines a target value of the direct current transmission voltage based on a correlation relationship by the correlating unit and which controls the voltage adjusting circuit based on the target value of the direct current transmission voltage.

8. The power generation device equipped on a vehicle according to claim 7, further comprising:
a rotation rate target value determining unit which determines a rotation rate target value for controlling stopping of the engine; and
a torque target value determining unit which determines a target value of torque applied to the generator based on a proportional integration calculation based on a difference between the rotation rate detection value and the rotation rate target value, wherein
the voltage adjusting circuit controlling unit determines the target value of the direct current transmission voltage based on the rotation rate detection value and the target value determined by the torque target value determining unit.

9. A power generation device equipped on a vehicle, comprising:
an engine which generates torque by combustion of fuel;
a generator wherein the engine and the generator apply torque to each other; and
a power adjusting unit to which the generator is connected, and which sends and receives power to and from a vehicle driving unit that drives the vehicle with the power and which adjusts the power sent to and received from the vehicle driving unit, wherein
the power adjusting unit comprises:
a conversion circuit which converts alternate current power generated by the generator into direct current power and outputs the direct current power to a power path to the vehicle driving unit; and
a voltage adjusting circuit which adjusts a direct current transmission voltage which is transmitted to the power path between the conversion circuit and the vehicle driving unit, and
the voltage adjusting circuit adjusts the direct current transmission voltage based on power to be sent and received between the power adjusting unit and the vehicle driving unit when the generator does not generate power and adjusts the direct current transmission voltage based on power to be generated by the generator when the generator generates power.

10. A power generation device equipped on a vehicle, comprising:
an engine which generates torque by combustion of fuel;
a generator wherein the engine and the generator apply torque to each other; and
a power adjusting unit to which the generator is connected, and which sends and receives power to and from a vehicle driving unit that drives the vehicle with the power and which adjusts the power sent to and received from the vehicle driving unit, wherein
the power adjusting unit comprises:
a conversion circuit which converts alternate current power generated by the generator into direct current power and outputs the direct current power to a power path to the vehicle driving unit; and
a voltage adjusting circuit which adjusts a direct current transmission voltage which is transmitted to the power path between the conversion circuit and the vehicle driving unit,
the voltage adjusting circuit comprises:
an electricity accumulating unit which applies a voltage to the power path to the vehicle driving unit; and
a converter circuit which boosts a voltage which is output from the generator through the conversion circuit and applies the boosted voltage to the power path to the vehicle driving unit and the electricity accumulating unit as the direct current transmission voltage, and
the direct current transmission voltage is adjusted with the voltage boosting operation.

11. The power generation device equipped on a vehicle according to claim 10, further comprising:
a vibration inhibition target value determining unit which determines a target value of the direct current transmission voltage for inhibiting a rotational vibration of the generator as a vibration inhibition target value;
a running control target value determining unit which determines a target value of the direct current transmission voltage corresponding to a running state and a drive operation of the vehicle as a running control target value; and
a vibration inhibition/running control target value determining unit which determines a target value of the direct current transmission voltage as a vibration inhibition/running control target value based on the vibration inhibition target value and the running control target value, wherein
the converter circuit operates in a manner such that the direct current transmission voltage reaches the vibration inhibition/running control target value.

12. The power generation device equipped on vehicle according to claim 11, wherein
the vibration inhibition target value determining unit comprises:
a correlating unit which correlates a rotation rate detection value of the generator, a target value of torque applied to the generator, and a target value of the direct current transmission voltage based on a rotation rate-torque characteristic for the generator, with the direct current transmission voltage as a parameter; and
a torque target value determining unit which determines a target value of torque applied to the generator for inhibiting the rotational vibration of the generator, and
the vibration inhibition target value is determined based on the rotation rate detection value of the generator, the target value determined by the torque target value determining unit, and a correlation relationship by the correlating unit.

13. The power generation device equipped on a vehicle according to claim 11, wherein
the generator operates in a generator operation range in a rotation rate-torque characteristic in which torque applied to the generator increases with an increase in a rotation rate of the generator under a condition that the direct current transmission voltage is constant,
a rotation rate-torque characteristic for the engine is set such that an engine operation range in the rotation rate-torque characteristic overlaps the generator operation range,
the running control target value determining unit comprises a generation power target value determining unit which determines a generation power target value corresponding to the running state and the drive operation of the vehicle, and
the running control target value is determined based on torque applied to the generator and a rotation rate of the generator corresponding to the generation power target value, rotation rate-torque characteristics for the engine and the generator in an overlapping range of the generator operation range and the engine operation range, and an optimum fuel consumption rate characteristic for the engine in the overlapping range.

14. The power generation device equipped on a vehicle according to claim 12, wherein
the generator operates in a generator operation range in a rotation rate-torque characteristic in which torque applied to the generator increases with an increase in a rotation rate of the generator under a condition that the direct current transmission voltage is constant,
a rotation rate-torque characteristic for the engine is set such that an engine operation range in the rotation rate-torque characteristic overlaps the generator operation range,
the running control target value determining unit comprises a generation power target value determining unit which determines a generation power target value corresponding to the running state and the drive operation of the vehicle, and
the running control target value is determined based on torque applied to the generator and a rotation rate of the generator corresponding to the generation power target value, rotation rate-torque characteristics for the engine and the generator in an overlapping range of the generator operation range and the engine operation range, and an optimum fuel consumption rate characteristic for the engine in the overlapping range.

15. A power generation device equipped on a vehicle, comprising:
an engine which generates torque by combustion of fuel;
a generator wherein the engine and the generator apply torque to each other; and
a power adjusting unit to which the generator is connected, and which sends and receives power to and from a vehicle driving unit that drives the vehicle with the power and which adjusts the power sent to and received from the vehicle driving unit, wherein
the power adjusting unit comprises:
a conversion circuit which converts alternate current power generated by the generator into direct current power and outputs the direct current power to a power path to the vehicle driving unit; and
a voltage adjusting circuit which adjusts a direct current transmission voltage which is transmitted to the power path between the conversion circuit and the vehicle driving unit,
the voltage adjusting circuit comprises:
an electricity accumulating unit which applies a voltage to the power path to the vehicle driving unit; and
a converter circuit which reduces a voltage which is output from the generator through the conversion circuit and applies the reduced voltage to the power path to the vehicle driving unit and the electricity accumulating unit, and
a voltage which is output from the generator through the conversion circuit is set as the direct current transmission voltage, and the direct current transmission voltage is adjusted with the voltage reducing operation.

16. The power generation device equipped on a vehicle according to claim 15, further comprising:
a vibration inhibition target value determining unit which determines a target value of the direct current transmission voltage for inhibiting a rotational vibration of the generator as a vibration inhibition target value;
a running control target value determining unit which determines a target value of the direct current transmission voltage corresponding to a running state and a drive operation of the vehicle as a running control target value; and
a vibration inhibition/running control target value determining unit which determines a target value of the direct current transmission voltage as a vibration inhibition/running control target value based on the vibration inhibition target value and the running control target value, wherein
the converter circuit operates in a manner such that the direct current transmission voltage reaches the vibration inhibition/running control target value.

17. The power generation device equipped on a vehicle according to claim 16, wherein
the vibration inhibition target value determining unit comprises:
a correlating unit which correlates a rotation rate detection value of the generator, a target value of torque applied to the generator, and a target value of the direct current transmission voltage based on a rotation rate-torque characteristic for the generator, with the direct current transmission voltage as a parameter; and
a torque target value determining unit which determines a target value of torque applied to the generator for inhibiting the rotational vibration of the generator, and
the vibration inhibition target value is determined based on the rotation rate detection value of the generator, the target value determined by the torque target value determining unit, and a correlation relationship by the correlating unit.

18. The power generation device equipped on a vehicle according to claim 16, wherein
the generator operates in a generator operation range in a rotation rate-torque characteristic in which torque applied to the generator increases with an increase in a rotation rate of the generator under a condition that the direct current transmission voltage is constant,
a rotation rate-torque characteristic for the engine is set such that an engine operation range in the rotation rate-torque characteristic overlaps the generator operation range,
the running control target value determining unit comprises a generation power target value determining unit which determines a generation power target value corresponding to the running state and the drive operation of the vehicle, and
the running control target value is determined based on torque applied to the generator and a rotation rate of the generator corresponding to the generation power target value, rotation rate-torque characteristics for the engine and the generator in an overlapping range of the generator operation range and the engine operation range, and an optimum fuel consumption rate characteristic for the engine in the overlapping range.

19. The power generation device equipped on a vehicle according to claim 17, wherein
the generator operates in a generator operation range in a rotation rate-torque characteristic in which torque applied to the generator increases with an increase in a rotation rate of the generator under a condition that the direct current transmission voltage is constant,
a rotation rate-torque characteristic for the engine is set such that an engine operation range in the rotation rate-torque characteristic overlaps the generator operation range,
the running control target value determining unit comprises a generation power target value determining unit which determines a generation power target value corresponding to the running state and the drive operation of the vehicle, and
the running control target value is determined based on torque applied to the generator and a rotation rate of the generator corresponding to the generation power target value, rotation rate-torque characteristics for the engine and the generator in an overlapping range of the generator operation range and the engine operation range, and an optimum fuel consumption rate characteristic for the engine in the overlapping range.
